(19) United States
(12) Patent Application Publication
(10) Pub. No.: US 2019/0189062 A1
(43) Pub. Date: Jun. 20, 2019

(54) System and Method of Controlling Light Emissions of Displays

(71) Applicant: Dell Products L.P., Round Rock, TX (US)

(72) Inventors: Aida Isabel Suarez, Austin, TX (US); Ray Vivian Kacelenga, Austin, TX (US); Deeder M. Aurongzeb, Austin, TX (US)

(21) Appl. No.: 15/847,233

(22) Filed: Dec. 19, 2017

(51) Int. Cl. G09G 3/34; G09G 3/36; G02F 1/1334

(52) U.S. Cl. CPC G09G 3/346; G09G 3/36; G02F 1/1334; G09G 2320/028; G09G 2320/08; G09G 2320/062; G09G 2358/00

(57) ABSTRACT

In one or more embodiments, a display device may display first information via first light emissions of via a first zone and second information via second light emissions of via a second zone and may obscure, via an anisotropic material, the first information along a first axis of the first zone and within a first threshold angle of the first zone and the second information along a first axis of the second zone and within a first threshold angle of the second zone. In one or more embodiments, the display device may further obscure, via the anisotropic material, the first information along a second axis of the first zone and within a second threshold angle of the first zone and may further obscure, via the anisotropic material, the second information along a second axis of the second zone and within a second threshold angle of the second zone.

### BACKGROUND

### Field of the Disclosure

This disclosure relates generally to information handling systems and more particularly to privacy for displays associated with information handling systems.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In one or more embodiments, a display device may display first information via first light emissions of a first zone and may display second information via second light emissions of a second zone. An anisotropic material, of the display device, may obscure the first information along a first axis of the first zone and within a first threshold angle of the first zone and may obscure the second information along a first axis of the second zone and within a first threshold angle of the second zone. In one or more embodiments, the anisotropic material may further obscure the first information along a second axis of the first zone and within a second threshold angle of the first zone and may further obscure the second information along a second axis of the second zone and within a second threshold angle of the second zone. In one example, the second threshold angle may be the first threshold angle. In another example, the second threshold angle may be different from the first threshold angle. In one or more embodiments, a media classification may be determined. For example, the anisotropic material may obscure the first information along the second axis of the first zone and within the second threshold angle of the first zone in response to the determination of the media classification.

In one or more embodiments, the anisotropic material may permit the first information along the first axis of the first zone to be viewed by at least one person. In one or more embodiments, the anisotropic material may include a first strips, having a first height, associated with the first axis and second strips, having a second height, associated with the second axis. In one example, the first strips may include non-cubic crystal structures that restrict the first light emissions of the first zone via absorbing at least a portion of the light emissions, along the second axis of the first zone and within the second threshold angle of the first zone, or via diffusing the at least portion of the first light emissions, along the second axis of the first zone and within the second threshold angle of the first zone. In another example, the first information may be displayed via a first portion of the first light emissions, and the first strips may obscure the first portion of the first light emissions.

### BRIEF DESCRIPTION OF THE DRAWINGS

For a more complete understanding of the present disclosure and its features/advantages, reference is now made to the following description, taken in conjunction with the accompanying drawings, which are not drawn to scale, and in which:

FIG. 1A illustrates an example of an information handling system, according to one or more embodiments;

FIG. 1B illustrates an example of an information handling system coupled to one or more display devices, according to one or more embodiments;

FIG. 1C illustrates an example of an information handling system that includes one or more display devices, according to one or more embodiments;

FIG. 2A illustrates an example of a portion of a display device, according to one or more embodiments;

FIG. 2B illustrates an example of louvers of a display device, according to one or more embodiments;

FIG. 2C illustrates another example of louvers of a display device, according to one or more embodiments;

FIG. 2D illustrates an example of threshold angles of a display device, according to one or more embodiments;

FIGS. 2E and 2F illustrate examples of voltage sources applied to louvers, according to one or more embodiments;

FIGS. 2G and 2H illustrate examples of turning films of a display device, according to one or more embodiments;

FIGS. 2I and 2J illustrate examples of turning films and polarizing films of a display device, according to one or more embodiments;

FIGS. 2K and 2L illustrate examples of light control films and louvers of a display device, according to one or more embodiments;

FIGS. 3A-3F illustrates example display devices, according to one or more embodiments;

FIG. 4 illustrates an example of an embedded controller and sensors, according to one or more embodiments;

FIG. 5 illustrates an example of a method of enabling privacy of a display device, according to one or more embodiments;

FIG. 6A illustrates an example of an information handling system in a clamshell mode, according to one or more embodiments;

FIG. 6B illustrates an example of an information handling system lying on a surface, according to one or more embodiments;

FIGS. 6C and 6D illustrates examples of an information handling system in a 360 mode, according to one or more embodiments;

FIG. 7 illustrates an example of a method of determining a 180 mode, according to one or more embodiments;

FIG. 8 illustrates an example of a method of utilizing vectors in determining a 180 mode, according to one or more embodiments;

FIG. 9 illustrates an example of a method of controlling light emissions of a display device, according to one or more embodiments;

FIG. 10A illustrates a display with multiple zones, according to one or more embodiments;

FIG. 10B illustrates an example of users of a display, according to one or more embodiments;

FIG. 10C illustrates an example of users that may not utilize a display, according to one or more embodiments;

FIG. 10D illustrates another example of users of a display, according to one or more embodiments;

FIG. 11A illustrates an example of a method of operating an information handling system is illustrated, according to one or more embodiments;

FIG. 11B illustrates an example block diagram of a machine learning system, according to one or more embodiments;

FIG. 12 illustrates an example method of operating displays, according to one or more embodiments; and

FIG. 13 illustrates an example method of operating zones of a display, according to one or more embodiments.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a reference numeral refers to a class or type of entity, and any letter following such reference numeral refers to a specific instance of a particular entity of that class or type. Thus, for example, a hypothetical entity referenced by ‘12A’ may refer to a particular instance of a particular class/type, and the reference ‘12’ may refer to a collection of instances belonging to that particular class/type or any one instance of that class/type in general.

In one or more embodiments, a display device may be utilized via various orientations and/or angles. In one example, the display device may be rotated by ninety degrees. For instance, the display device may be rotated from a landscape orientation to a portrait orientation. In another example, the display device may be rotated by one hundred and eighty degrees. For instance, the display device may be associated with a laptop that includes tablet-like features.

In one or more embodiments, one or more privacy filters may include tiny blinds called micro louvers, which may be built into the one or more privacy filters. For example, the one or more privacy filters may allow light emissions to pass straight on through but not sideways. For instance, the one or more privacy filters may block or obscure the light emissions at an angle greater than thirty degrees on either side of a screen or display device. In one or more embodiments, the one or more privacy filters may allow a user of an information handling system to see what is on the screen or display device, and any bystander's view of content, via the light emissions, may be blocked or obscured when viewing the screen or display device outside of a viewing region (e.g., greater than thirty degrees on either side of the screen or display device). For example, the one or more privacy filters may be controllable by the user. For instance, the one or more privacy filters may be turned on or off based on input from the user.

In one or more embodiments, privacy of information conveyed via the display device may be conveyed after the display device is rotated. For example, the display device may include a switchable diffuser that is configured to provide privacy of information conveyed via the display device after the display device is rotated and/or after an orientation of the display device is changed. For instance, the switchable diffuser that is configured to provide privacy of information conveyed via the display device may provide privacy protection associated with left side and/or right side intrusions and may continue to provide privacy protection associated with left-side and/or right-side intrusions after the display device is rotated and/or after an orientation of the display device is changed.

In one or more embodiments, privacy of information conveyed via the display device may be associated with a top down and/or bottom up intrusions. In one example, a person looking down on the display device may not be able to decipher information conveyed via the display device. In another example, the display device may be on or within a horizontal surface (e.g., a surface of a table, a desk, a counter, etc.), and a person looking towards a top of the display device may not be able to decipher information conveyed via the display device.

In one or more embodiments, a display may provide simultaneous multi-media presentation capabilities. For example, different zones of the display may be utilized in providing different content to multiple people. In one or more embodiments, the display may provide privacy of first information via a first zone, may provide privacy of second information via a second zone, may provide privacy of third information via a third zone, etc. In one example, the display may provide zone privacy via one or more angles along one or more axes. In another example, the display may provide zone privacy via one or more distances from the display. For instance, providing zone privacy via the one or more distances from the display may include providing zone privacy via one or more angles with respect to an axis that is orthogonal to two or more other axes of the display.

In one or more embodiments, one or more contexts may activate and/or initiate screen privacy. For example, the one or more contexts may include one or more of an orientation context, a location context, an ambient audio context, and a document classification context, among others. In one or more embodiments, an orientation context may pertain to a detection and/or a determination of an information handling system orientation and screen mode using one or more sensors of the information handling system. For example, the one or more sensors of the information handling system may include one or more of a three-axis accelerometer, a three-axis gyroscope, and a three-axis magnetometer, among others.

In one or more embodiments, a location context may pertain to a detection and/or a determination of a location of an information handling system orientation. For example, detecting and/or determining a location of the information handling system may include utilizing one or more of a WiFi communication technology, a wireless wide area network (WWAN) communication technology, a Bluetooth communication technology, and a Global Navigation Satellite System (GNSS) communication technology, among others. In one instance, a location engine may process data from one or more sources and may calculate and/or determine a location of the information handling system with respect to one or more reference frames. In another instance, a location of the information handling system may be mapped to a semantically meaningful location such as “WORK”, “HOME”, “AIRPORT”, etc.

In one or more embodiments, an ambient audio context may pertain to a detection and/or a determination of an environment. For example, an audio engine may receive audio information and may detect and/or determinate an environment based on the audio information. In one or more embodiments, a sound pressure level may be associated with an environment. For example, the sound pressure level may indicate an environment. In one instance, a “quiet” environment may be associated with a sound pressure level below 30 decibels. In a second instance, “speech” may be associated with a sound pressure level above 40 decibels and less than 60 decibels. In a third instance, a “noisy” environment may be associated with a sound pressure level above 60 decibels and below 80 decibels. In another instance, a “very noisy” environment may be associated with a sound pressure level above 80 decibels. In one or more embodiments, a machine learning model may be trained to determine an environment based at least on audio information. For example, the machine learning model may be trained to determine one or more of a mall, a cafeteria, an airport, and an airplane, among others, based at least on received audio information.

In one or more embodiments, training a machine learning model may include utilizing a collection of data that are representative of an environment and extracting invariant features (e.g., invariant features of a time domain, a frequency domain, etc.). For example, the collection of data that are representative of the environment may be utilized in forming representative feature vectors. In one or more embodiments, some feature vectors may be utilized in training models of various forms. For example, the models may include one or more mathematical models, among others. In one or more embodiments, some feature vectors may be utilized in testing the models for recall accuracy and/or precision. For example, sound pressure levels may be subsumed in one or more feature vectors. For instance, the sound pressure levels may not be a dominate classifier in classifying an audio environment. In one or more embodiments, after an information handling system has learned user privacy preferences for the audio environments, the privacy preferences may be automatically applied to one or more display modes. For example, the display modes may include a landscape mode, a portrait mode, and/or a 180 mode, among others.

In one or more embodiments, a document classification context may pertain to a detection and/or a determination of a media file classification. For example, a media file classification may include “no restriction”, “restricted”, “internal use”, or “critical handling”, among others. For instance, display privacy, based at least on a media file classification, may include “none”, “horizontal”, “vertical”, or “all around”.

In one or more embodiments, a display device may include a switchable diffuser of polymer dispersed liquid crystals (PDLC). For example, the switchable diffuser may provide privacy of information conveyed via the display device. For instance, the information conveyed via the display device may not be viewed by a person along an axis of the display device and within a threshold angle. In one or more embodiments, the PDLC may include non-cubic crystal structures that restrict the light emissions of the display device. For example, the non-cubic crystal structures may absorb at least a portion of light emissions, along the axis of the display device and within the threshold angle, and/or may diffuse the at least portion of the light emissions, along the axis of the display device and within the threshold angle.

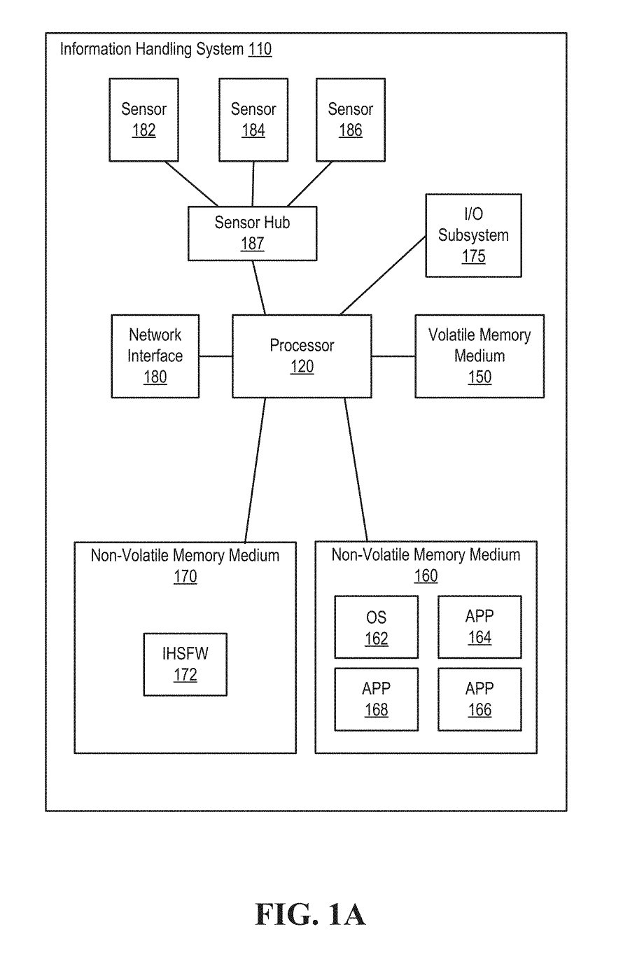

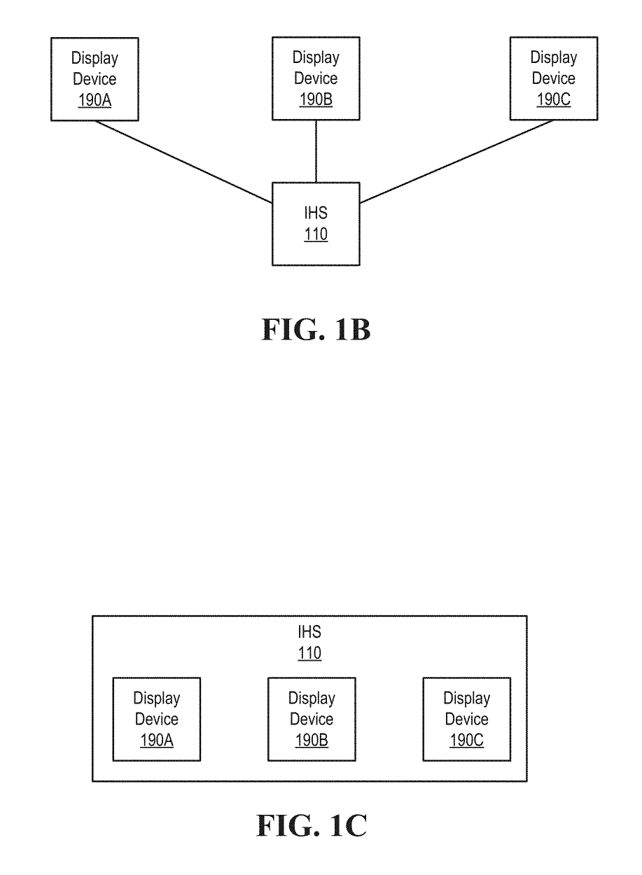

Turning now to FIG. 1A, an example of an information handling system is illustrated, according to one or more embodiments. An information handling system (IHS) 110 may include a hardware resource or an aggregate of hardware resources operable to compute, classify, process, transmit, receive, retrieve, originate, switch, store, display, manifest, detect, record, reproduce, handle, and/or utilize various forms of information, intelligence, or data for business, scientific, control, entertainment, or other purposes, according to one or more embodiments. For example, IHS 110 may be a personal computer, a desktop computer system, a laptop computer system, a server computer system, a mobile device, a personal digital assistant (PDA), a consumer electronic device, an electronic music player, an electronic camera, an electronic video player, a wireless access point, a network storage device, or another suitable device and may vary in size, shape, performance, functionality, and price. In one or more embodiments, components of IHS 110 may include one or more storage devices, one or more communications ports for communicating with external devices as well as various input and output (I/O) devices, such as a keyboard, a mouse, and a video display, among others. In one or more embodiments, IHS 110 may include one or more buses operable to transmit communication between or among two or more hardware components. In one example, a bus of IHS 110 may include one or more of a memory bus, a peripheral bus, and a local bus, among others. In another example, a bus of IHS 110 may include one or more of a Micro Channel Architecture (MCA) bus, an Industry Standard Architecture (ISA) bus, an Enhanced ISA (EISA) bus, a Peripheral Component Interconnect (PCI) bus, HyperTransport (HT) bus, an inter-integrated circuit (I²C) bus, a serial peripheral interface (SPI) bus, a low pin count (LPC) bus, an enhanced serial peripheral interface (eSPI) bus, a universal serial bus (USB), a system management bus (SMBus), and a Video Electronics Standards Association (VESA) local bus, among others.

In one or more embodiments, IHS 110 may include firmware that controls and/or communicates with one or more hard drives, network circuitry, one or more memory devices, one or more I/O devices, and/or one or more other peripheral devices. For example, firmware may include software embedded in an IHS component utilized to perform tasks. In one or more embodiments, firmware may be stored in non-volatile memory, such as storage that does not lose stored data upon loss of power. In one example, firmware associated with an IHS component may be stored in non-volatile memory that is accessible to one or more IHS components. In another example, firmware associated with an IHS component may be stored in non-volatile memory that may be dedicated to and includes part of that component. For instance, an embedded controller may include firmware that may be stored via non-volatile memory that may be dedicated to and includes part of the embedded controller.

As shown, IHS 110 may include a processor 120, a volatile memory medium 150, non-volatile memory media 160 and 170, an I/O subsystem 175, a network interface 180, sensors 182-186, and a sensor hub 187. As illustrated, volatile memory medium 150, non-volatile memory media 160 and 170, I/O subsystem 175, network interface 180, and sensor hub 187 may be communicatively coupled to processor 120. In one or more embodiments, sensors 182-186 may be communicatively coupled to processor 120 via sensor hub 187. In one example, sensor hub 187 may be a discrete sensor hub. In another example, sensor hub 187 may be an integrated sensor hub. For instance, sensor hub may be integrated into a system on chip that includes processor 120. In one or more embodiments, one or more of sensors 182-186 may include one or more of a thermistor, a Hall effect sensor, an accelerometer, and a gyroscope, among other sensors. For example, the Hall effect sensor may be utilized in determining an opening and/or a closing of a lid of a laptop IHS.

In one or more embodiments, one or more of volatile memory medium 150, non-volatile memory media 160 and 170, I/O subsystem 175, and network interface 180 may be communicatively coupled to processor 120 via one or more buses, one or more switches, and/or one or more root complexes, among others. In one example, one or more of volatile memory medium 150, non-volatile memory media 160 and 170, I/O subsystem 175, and network interface 180 may be communicatively coupled to processor 120 via one or more PCI-Express (PCIe) root complexes. In another example, one or more of an I/O subsystem 175 and a network interface 180 may be communicatively coupled to processor 120 via one or more PCIe switches.

In one or more embodiments, the term “memory medium” may mean a “storage device”, a “memory”, a “memory device”, a “tangible computer readable storage medium”, and/or a “computer-readable medium”. For example, computer-readable media may include, without limitation, storage media such as a direct access storage device (e.g., a hard disk drive, a floppy disk, etc.), a sequential access storage device (e.g., a tape disk drive), a compact disk (CD), a CD-ROM, a digital versatile disc (DVD), a random access memory (RAM), a read-only memory (ROM), a one-time programmable (OTP) memory, an electrically erasable programmable read-only memory (EEPROM), and/or a flash memory, a solid state drive (SSD), or any combination of the foregoing, among others.

In one or more embodiments, one or more protocols may be utilized in transferring data to and/or from a memory medium. For example, the one or more protocols may include one or more of small computer system interface (SCSI), Serial Attached SCSI (SAS) or another transport that operates with the SCSI protocol, advanced technology attachment (ATA), serial ATA (SATA), a USB interface, an Institute of Electrical and Electronics Engineers (IEEE) 1394 interface, a Thunderbolt interface, an advanced technology attachment packet interface (ATAPI), serial storage architecture (SSA), integrated drive electronics (IDE), or any combination thereof, among others.

Volatile memory medium 150 may include volatile storage such as, for example, RAM, DRAM (dynamic RAM), EDO RAM (extended data out RAM), SRAM (static RAM), etc. One or more of non-volatile memory media 160 and 170 may include nonvolatile storage such as, for example, a read only memory (ROM), a programmable ROM (PROM), an erasable PROM (EPROM), an electrically erasable PROM, NVRAIVI (non-volatile RAM), ferroelectric RAM (FRAM), a magnetic medium (e.g., a hard drive, a floppy disk, a magnetic tape, etc.), optical storage (e.g., a CD, a DVD, a BLU-RAY disc, etc.), flash memory, a SSD, etc. In one or more embodiments, a memory medium can include one or more volatile storages and/or one or more nonvolatile storages.

In one or more embodiments, network interface 180 may be utilized in communicating with one or more networks and/or one or more other information handling systems. In one example, network interface 180 may enable IHS 110 to communicate via a network utilizing a suitable transmission protocol and/or standard. In a second example, network interface 180 may be coupled to a wired network. In a third example, network interface 180 may be coupled to an optical network. In another example, network interface 180 may be coupled to a wireless network.

In one or more embodiments, network interface 180 may be communicatively coupled via a network to a network storage resource. For example, the network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, an Internet or another appropriate architecture or system that facilitates the communication of signals, data and/or messages (generally referred to as data). For instance, the network may transmit data utilizing a desired storage and/or communication protocol, including one or more of Fibre Channel, Frame Relay, Asynchronous Transfer Mode (ATM), Internet protocol (IP), other packet-based protocol, Internet SCSI (i SCSI), or any combination thereof, among others.

In one or more embodiments, processor 120 may execute processor instructions in implementing one or more systems, flowcharts, methods, and/or processes described herein. In one example, processor 120 may execute processor instructions from one or more of memory media 150-170 in implementing one or more systems, flowcharts, methods, and/or processes described herein. In another example, processor 120 may execute processor instructions via network interface 180 in implementing one or more systems, flowcharts, methods, and/or processes described herein.

In one or more embodiments, processor 120 may include one or more of a system, a device, and an apparatus operable to interpret and/or execute program instructions and/or process data, among others, and may include one or more of a microprocessor, a microcontroller, a digital signal processor (DSP), an application specific integrated circuit (ASIC), and another digital or analog circuitry configured to interpret and/or execute program instructions and/or process data, among others. In one example, processor 120 may interpret and/or execute program instructions and/or process data stored locally (e.g., via memory media 150-170 and/or another component of IHS 110). In another example, processor 120 may interpret and/or execute program instructions and/or process data stored remotely (e.g., via a network storage resource).

In one or more embodiments, I/O subsystem 175 may represent a variety of communication interfaces, graphics interfaces, video interfaces, user input interfaces, and/or peripheral interfaces, among others. For example, I/O subsystem 175 may include one or more of a touch panel and a display adapter, among others. For instance, a touch panel may include circuitry that enables touch functionality in conjunction with a display that is driven by a display adapter.

As shown, non-volatile memory medium 160 may include an operating system (OS) 162, and applications (APPs) 164-168. In one or more embodiments, one or more of OS 162 and APPs 164-168 may include processor instructions executable by processor 120. In one example, processor 120 may execute processor instructions of one or more of OS 162 and APPs 164-168 via non-volatile memory medium 160. In another example, one or more portions of the processor instructions of the one or more of OS 162 and APPs 164-168 may be transferred to volatile memory medium 150, and processor 120 may execute the one or more portions of the processor instructions of the one or more of OS 162 and APPs 164-168 via volatile memory medium 150.

As illustrated, non-volatile memory medium 170 may include information handling system firmware (IHSFW) 172. In one or more embodiments, IHSFW 172 may include processor instructions executable by processor 120. For example, IHSFW 172 may include one or more structures and/or functionalities of one or more of a basic input/output system (BIOS), an Extensible Firmware Interface (EFI), a Unified Extensible Firmware Interface (UEFI), and an Advanced Configuration and Power Interface (ACPI), among others. In one instance, processor 120 may execute processor instructions of IHSFW 172 via non-volatile memory medium 170. In another instance, one or more portions of the processor instructions of IHSFW 172 may be transferred to volatile memory medium 150, and processor 120 may execute the one or more portions of the processor instructions of IHSFW 172 via volatile memory medium 150.

In one or more embodiments, processor 120 and one or more components of IHS 110 may be included in a system-on-chip (SoC). For example, the SoC may include processor 120 and a platform controller hub (not specifically illustrated).

Turning now to FIG. 1B, an example of an information handling system coupled to one or more display devices is illustrated, according to one or more embodiments. As shown, IHS 110 may be coupled to one or more of display devices 190A-190C.

Turning now to FIG. 1C, an example of an information handling system that includes one or more display devices is illustrated, according to one or more embodiments. As shown, IHS 110 may include one or more of display devices 190A-190C.

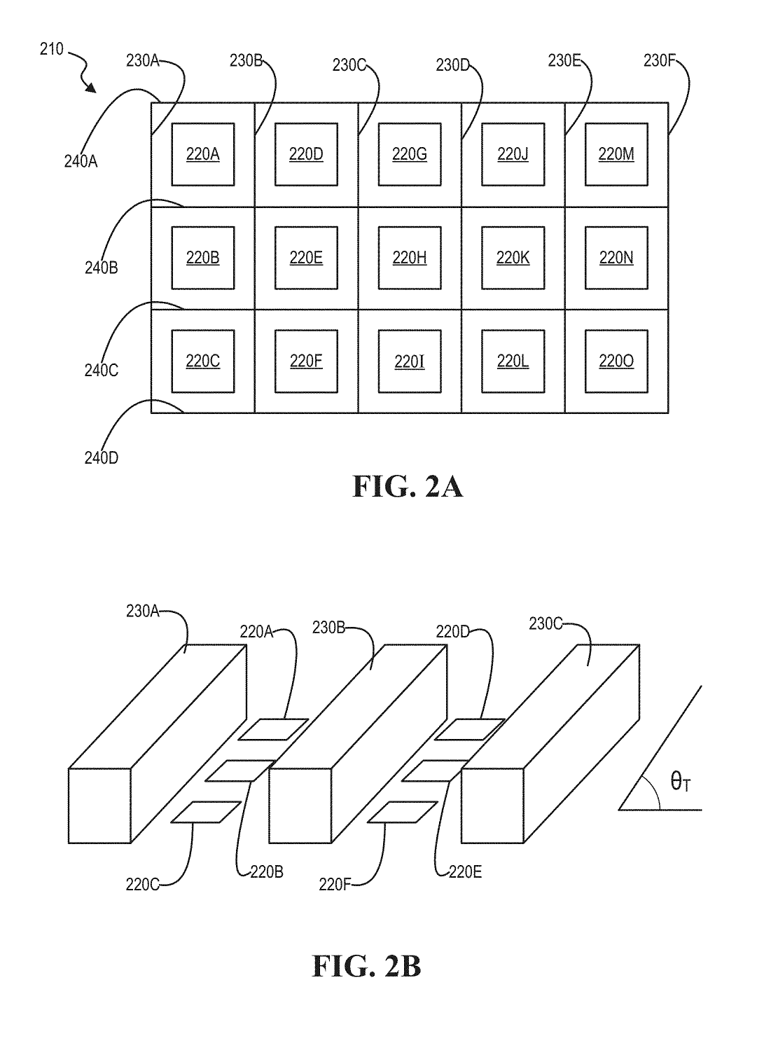

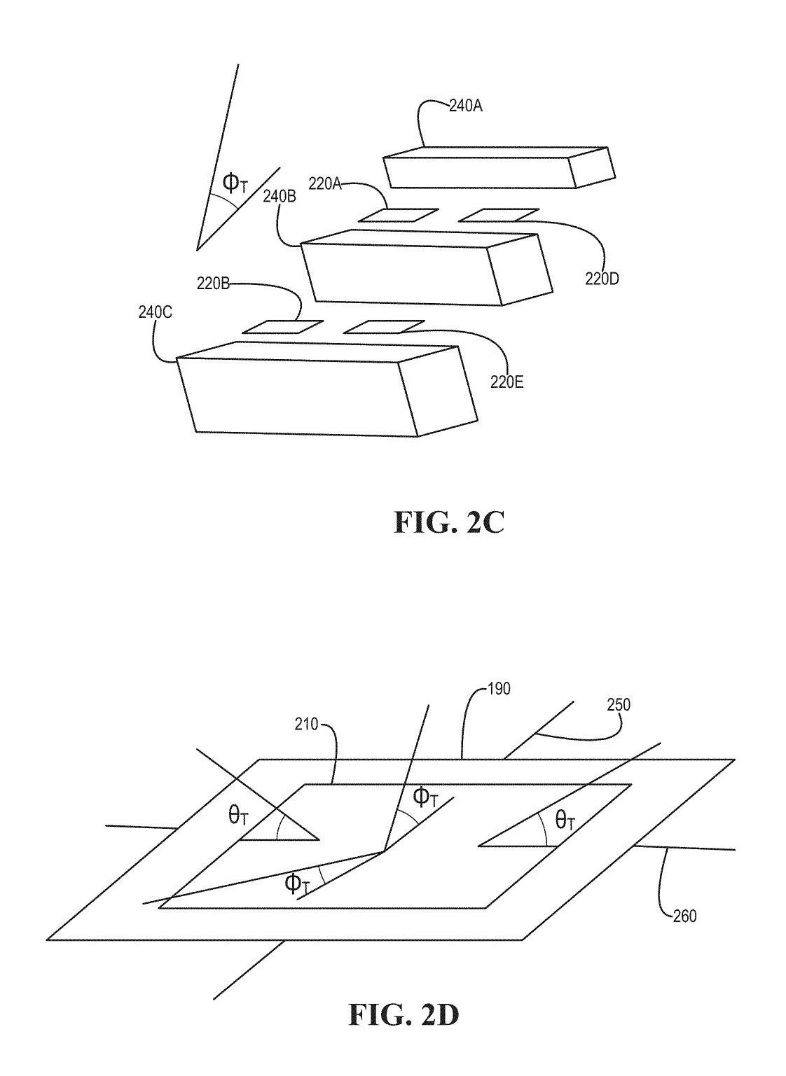

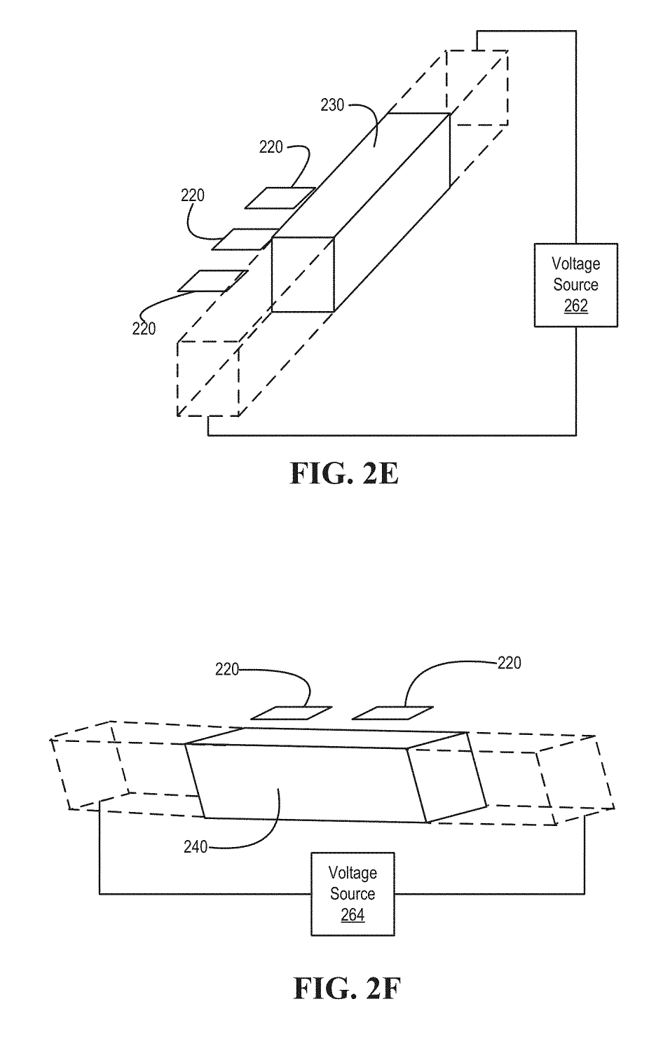

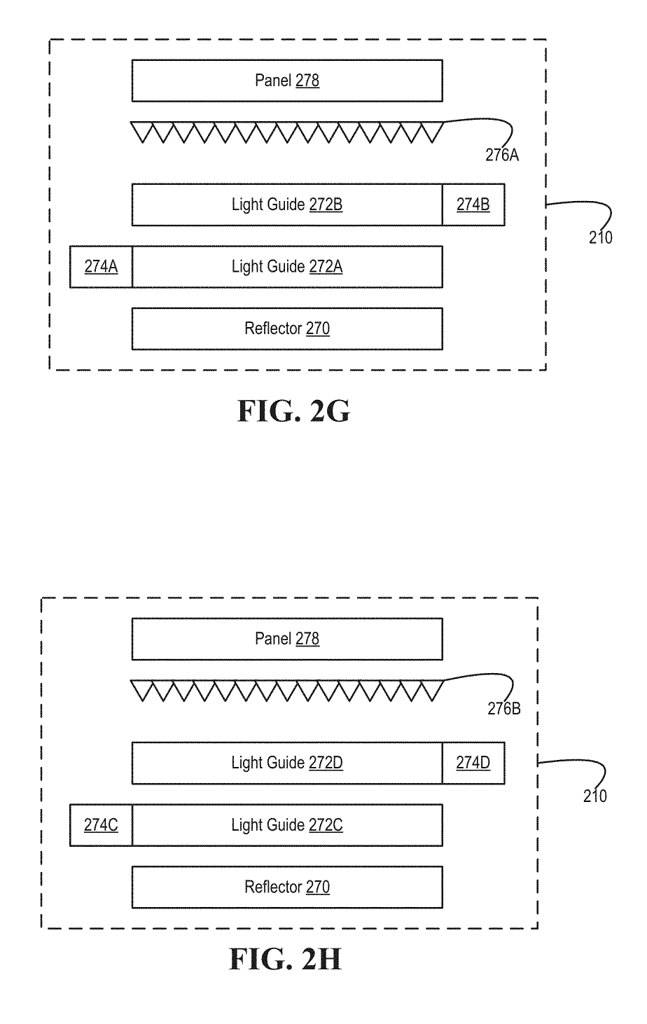

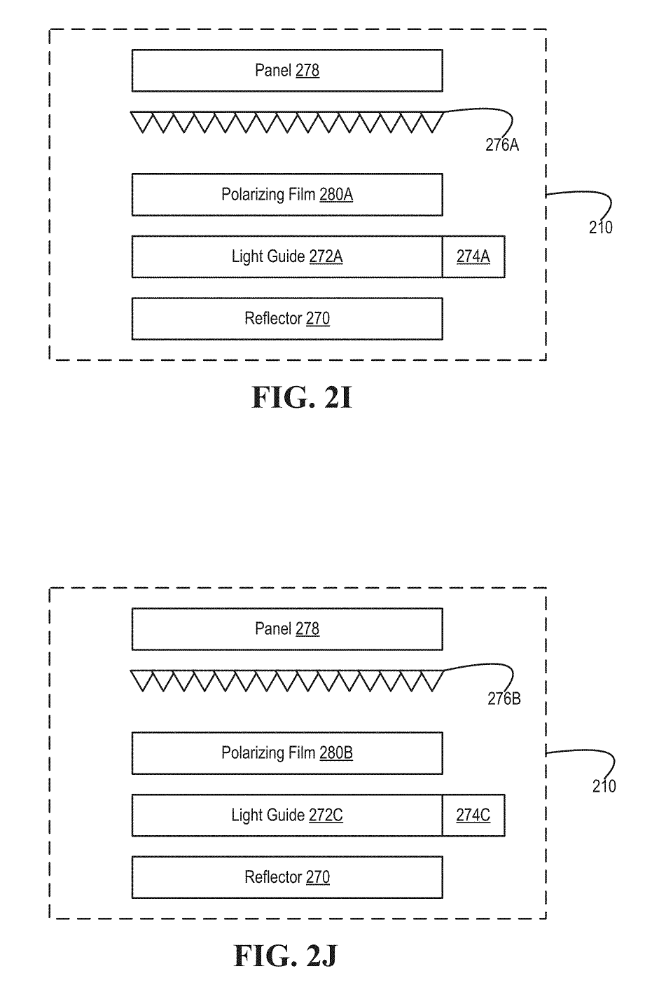

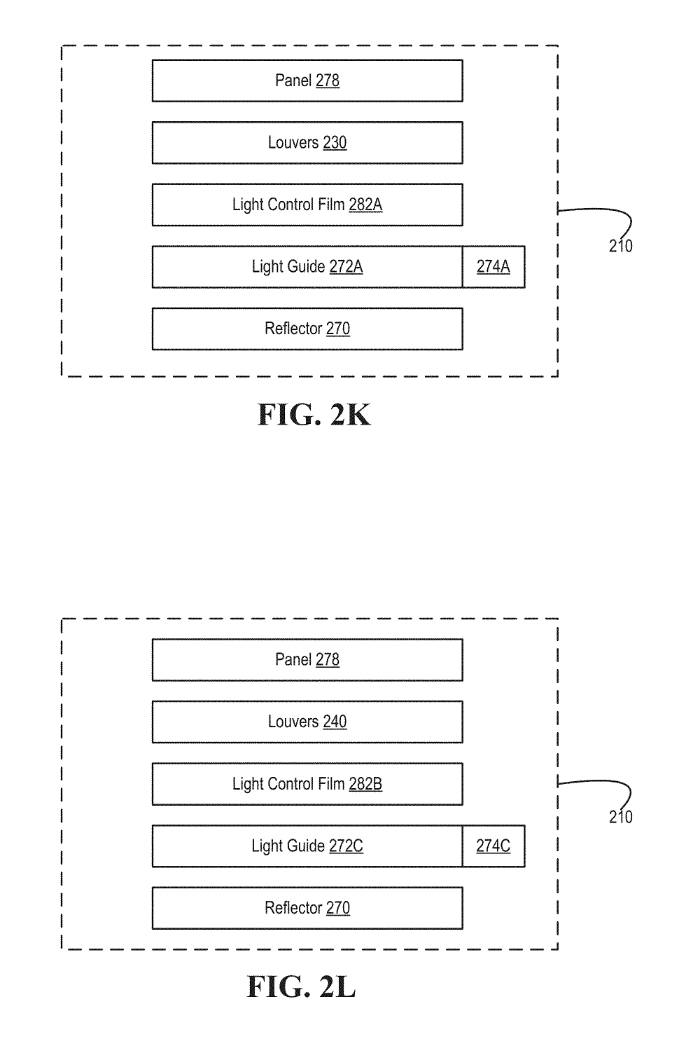

Turning now to FIG. 2A, an example of a portion of a display device is illustrated, according to one or more embodiments. As shown, a display portion 210 may include pixels 220A-2200. In one or more embodiments, pixel 220 may be or include a physical point in an image displayed by display device 190. For example, pixel 220 may be or include a smallest controllable element of an image represented via display device 190. For instance, display device 190 may convey information via pixels 220. In one or more embodiments, display device 190 may emit light via pixels 220. For example, display device 190 may emit different colors of light via pixels 220. In one instance, pixel 220 may emit a single color. In another instance, pixel 220 may emit light at an intensity.

As shown, display portion 210 may include louvers 230A-230D and 240A-240D. In one or more embodiments, each of louver 230 and louver 240 may be or include a strip that has a height. Although not specifically illustrated, one or more of louvers 230 and 240 may extend into another display portion, according to one or more embodiments.

In one or more embodiments, one or more of louver 230 and louver 240 may include non-cubic crystal structures. In one example, the non-cubic crystal structures may restrict light emissions of display device 190. For instance, the non-cubic crystal structures may be utilized in absorbing and/or diffusing at least a portion of light emissions of display device 190. In another example, one or more of louver 230 and louver 240 may include liquid crystals. For instance, the liquid crystals may be utilized in absorbing and/or diffusing at least a portion of light emissions of display device 190.

In one or more embodiments, one or more of louver 230 and louver 240 may include PDLC. For example, the PDLC of a louver may restrict light emissions of display device 190. In one or more embodiments, when no voltage (e.g., zero voltage) is applied to the PDLC of one or more of louver 230 and louver 240, the liquid crystals of the PDLC may be randomly arranged, which may scatter light emissions of display device 190. For example, the PDLC of one or more of louver 230 and louver 240 may absorb and/or diffuse at least a portion of light emissions of display device 190. In one or more embodiments, one or more voltages, greater than a zero voltage, may be applied to one or more of louver 230 and louver 240. For example, when applying the one or more voltages, greater than a zero voltage, to one or more of louver 230 and louver 240, an electrical current may pass through the PDLC, which may align crystals of the PDLC along parallel axes that may permit light emissions of display device 190 to pass through. For instance, one or more degrees of transparency of light emissions of display device 190 may be associated with respective the one or more applied voltages to one or more of louver 230 and louver 240. In one or more embodiments, lower voltages applied to one or more of louver 230 and louver 240 may align a few liquid crystals of the PDLC, which may permit a small portion of light emissions of display device 190. In one or more embodiments, as voltages applied to one or more of louver 230 and louver 240 increase, fewer of the liquid crystals of the PDLC may be out of alignment, which may permit an increase in permitted light emissions of display device 190. For example, one or more voltages applied to one or more of louver 230 and louver 240 may be utilized to control one or more amounts of light emissions of display device 190.

Turning now to FIG. 2B, an example of louvers of a display device is illustrated, according to one or more embodiments. As shown, louvers 230A and 230B may have a height. In one or more embodiments, louvers 230A and 230B may have a height above pixels 220A-220C. As illustrated, louver 230C may have a height. In one or more embodiments, louvers 230B and 230C may have a height above pixels 220D-220F.

In one or more embodiments, a threshold angle may be associated with louvers 230 when louvers 230 absorb and/or diffuse at least a portion of light emissions of display device 190. For example, at least a portion of light emissions of display device 190 may be absorbed and/or diffused by louvers 230 when a viewing angle is less than the threshold angle θ_{T} or greater than 180-θ_{T}. In one instance, information conveyed via pixels 220 may not be decipherable by a person when louvers 230 absorb and/or diffuse at least a portion of light emissions of display device 190 and a viewing angle is less than the threshold angle θ_{T} or greater than 180-θ_{T}. In another instance, information conveyed via pixels 220 may be decipherable by a person when a viewing angle is greater than the threshold angle θ_{T} and less than 180-θ_{T}.

Turning now to FIG. 2C, another example of louvers of a display device is illustrated, according to one or more embodiments. As shown, louvers 240A and 240B may have a height. In one or more embodiments, louvers 240A and 240B may have a height above pixels 220A and 220D. As illustrated, louver 240C may have a height. In one or more embodiments, louvers 240B and 240C may have a height above pixels 220B and 220E.

In one or more embodiments, a threshold angle may be associated with louvers 240 when louvers 240 absorb and/or diffuse at least a portion of light emissions of display device 190. For example, at least a portion of light emissions of display device 190 may be absorbed and/or diffused by louvers 240 when a viewing angle is less than the threshold angle θ_{T} or greater than 180-ϕ_{T}. In one instance, information conveyed via pixels 220 may not be decipherable by a person when louvers 240 absorb and/or diffuse at least a portion of light emissions of display device 190 and a viewing angle is less than the threshold angle ϕ_{T} or greater than 180-ϕ_{T}. In another instance, information conveyed via pixels 220 may be decipherable by a person when a viewing angle is greater than the threshold angle ϕ_{T} and less than 180-ϕ_{T}.

In one or more embodiments, louvers 230 and louvers 240 may be stacked. In one example, louvers 230 may be stacked on louvers 240. In another example, louvers 240 may be stacked on louvers 230. In one or more embodiments, louvers 230 and louvers 240 may form an anisotropic material. In one or more embodiments, an anisotropic material may include louvers 230 and louvers 240. In one or more embodiments, a filter may include louvers 230 and louvers 240. In one example, the filter may obscure and/or block information, via light emissions of a display device, at one or more viewing angles. In another example, the filter may permit and/or allow information, via light emissions of a display device, at one or more viewing angles.

Turning now to FIG. 2D, an example of threshold angles of a display device is illustrated, according to one or more embodiments. As shown, display device 190 may include display portion 210. In one or more embodiments, display device 190 may include other display portions 210. For example, display portion 210 may be for example and/or for illustrative purposes and may not actually exist within display device 190. As illustrated, the threshold angle ϕ_{T} or may be with reference to an axis 250, and the threshold angle θ_{T} may be with reference to an axis 260.

Turning now to FIGS. 2E and 2F, examples of voltage sources applied to louvers are illustrated, according to one or more embodiments. As shown in FIG. 2E, a voltage source 262 may apply a voltage to louver 230. The dashed sections of louver 230 indicate that louver 230 may be of any length. In one or more embodiments, voltage source 262 may apply a voltage to multiple louvers 230. For example, applying a voltage to multiple louvers 230 may actuate and/or engage louvers 230 such that louvers 230 may absorb, diffuse, and/or obscure at least a portion of light emissions of display device 190 and a viewing angle is less than the threshold angle θ_{T} or greater than 180-θ_{T} with respect to axis 260. For instance, a person may not be able to decipher information conveyed from display device 190 when a viewing angle is less than the threshold angle θ_{T} or greater than 180-θ_{T} with respect to axis 260 when a voltage from voltage source 262 is applied to louvers 230. In another example, information conveyed via pixels 220 may be decipherable by a person when a viewing angle is greater than the threshold angle θ_{T} and less than 180-θ_{T} with respect to axis 260 when a voltage is not applied to louvers 230.

As illustrated in FIG. 2F, a voltage source 264 may apply a voltage to louver 240. The dashed sections of louver 230 indicate that louver 240 may be of any length. In one or more embodiments, voltage source 264 may apply a voltage to multiple louvers 240. In one example, applying a voltage to multiple louvers 240 may actuate and/or engage louvers 240 such that louvers 240 may absorb, diffuse, and/or obscure at least a portion of light emissions of display device 190 and a viewing angle is less than the threshold angle ϕ_{T} or greater than 180-ϕ_{T} with respect to axis 250. For instance, a person may not be able to decipher information conveyed from display device 190 when a viewing angle is less than the threshold angle ϕ_{T} or greater than 180-ϕ_{T} with respect to axis 250 when a voltage from voltage source 264 is applied to louvers 240. In another example, information conveyed via pixels 220 may be decipherable by a person when a viewing angle is greater than the threshold angle ϕ_{T} and less than 180-ϕ_{T} with respect to axis 250 when a voltage is not applied to louvers 240. In one or more embodiments, one or more of voltage sources 262 and 264 may be controlled via one or more of processor 120 and an embedded controller 410 (described further below), among others.

Turning now to FIGS. 2G and 2H, examples of turning films of a display device are illustrated, according to one or more embodiments. As shown in FIG. 2G, display portion 210 may include a reflector 270, a light guide 272A, a light source 274A, a light guide 272B, a light source 274B, a turning film 276A, and a panel 278. As illustrated in FIG. 2H, display portion 210 may include reflector 270, a light guide 272C, a light source 274C, a light guide 272D, a light source 274D, a turning film 276B, and panel 278. In one or more embodiments, display portion 210 illustrated in FIG. 2G may be associated with axis 250. In one or more embodiments, display portion 210 illustrated in FIG. 2H may be associated with axis 260. In one or more embodiments, utilizing display portion 210 illustrated in FIGS. 2G and 2H may provide privacy along one or more of axes 250 and 260. In one or more embodiments, an anisotropic material may include one or more of light guide 272, light source 274, turning film 276, and panel 278, among others.

In one or more embodiments, a light guide 272 may transmit illumination provided by a light source 274. In one example, light source 274 may include one or more light emitting diodes (LEDs). In a second example, light source 274 may include one or more cold cathode fluorescent lights (CCFLs). In another example, light source 274 may include one or more incandescent light sources. In one or more embodiments, light sources 274 may be driven and/or illuminated, in a selective fashion, in producing variable and/or switchable distributions of light emissions. In one or more embodiments, turning film 276 may be optically transparent and may have a thickness. For example, turning film 276 may be associated with one or more attributes such as one or more of a low haze and a high clarity, among others. For instance, the one or more attributes of turning film 276 may reduce and/or eliminate undesirable scattering of incident light emissions. In one or more embodiments, turning film 276 may have a high index of refraction. For example, the index of refraction of turning film 276 may be one and one-half (1.5) or greater. In one or more embodiments, turning film 276 may be or include an asymmetric turning film. In one or more embodiments, panel 278 may include a liquid crystal display (LCD). In one or more embodiments, panel 278 may be or include a variable contrast panel.

Turning now to FIGS. 2I and 2J, examples of turning films and polarizing films of a display device are illustrated, according to one or more embodiments. As shown in FIG. 2I, display portion 210 may include reflector 270, light guide 272A, light source 274A, a polarizing film 280A, turning film 276A, and panel 278. As illustrated in FIG. 2J, display portion 210 may include reflector 270, light guide 272C, light source 274C, a polarizing film 280B, turning film 276B, and panel 278. In one or more embodiments, display portion 210 illustrated in FIG. 2I may be associated with axis 250. In one or more embodiments, display portion 210 illustrated in FIG. 2J may be associated with axis 260. In one or more embodiments, utilizing display portion 210 illustrated in FIGS. 2I and 2J may provide privacy along one or more of axes 250 and 260. In one or more embodiments, an anisotropic material may include one or more of light guide 272, light source 274, turning film 276, polarizing film 280, and panel 278, among others.

Turning now to FIGS. 2K and 2L, examples of light control films and louvers of a display device are illustrated, according to one or more embodiments. As shown in FIG. 2K, display portion 210 may include reflector 270, light guide 272A, light source 274A, a light control film 282A, louvers 230, and panel 278. As illustrated in FIG. 2L, display portion 210 may include reflector 270, light guide 272C, light source 274C, a light control film 282B, louvers 240, and panel 278. In one or more embodiments, display portion 210 illustrated in FIG. 2K may be associated with axis 250. In one or more embodiments, display portion 210 illustrated in FIG. 2L may be associated with axis 260. In one or more embodiments, utilizing display portion 210 illustrated in FIGS. 2K and 2L may provide privacy along one or more of axes 250 and 260. In one or more embodiments, an anisotropic material may include one or more of light guide 272, light source 274, turning film 276, light control film 282, louvers 230, louvers 240, and panel 278, among others.

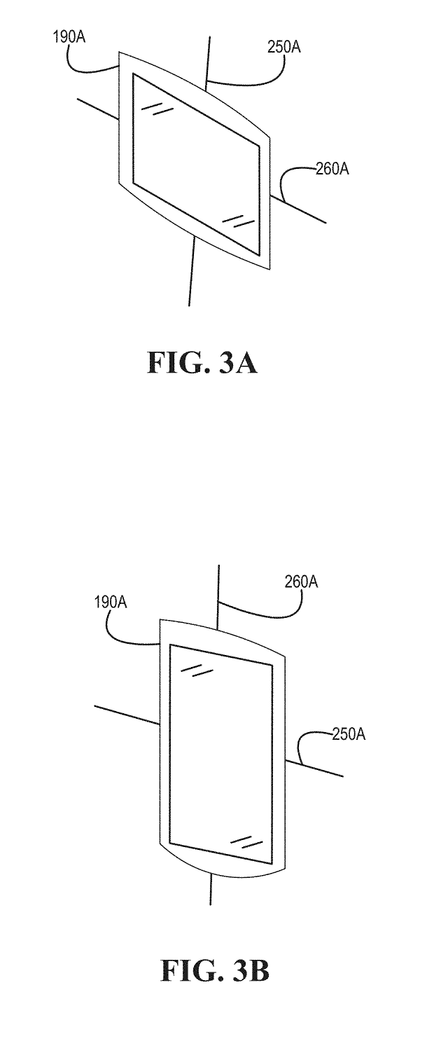

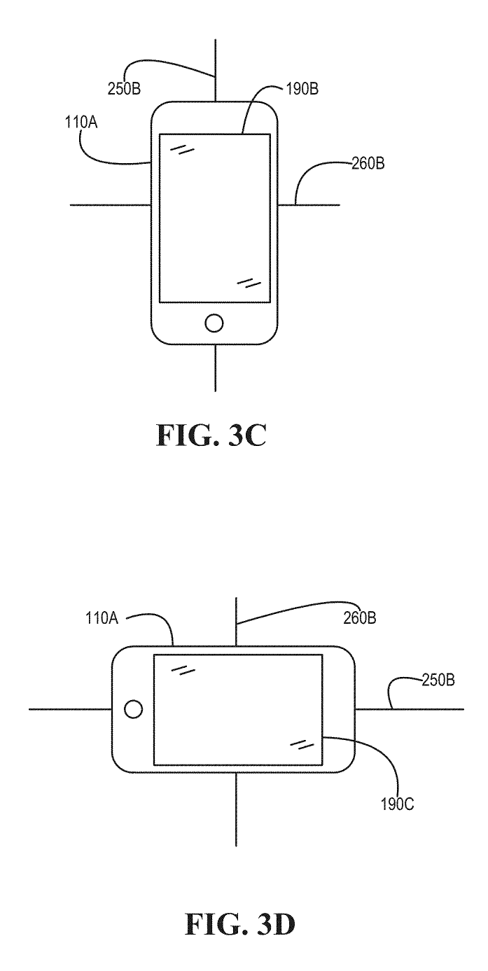

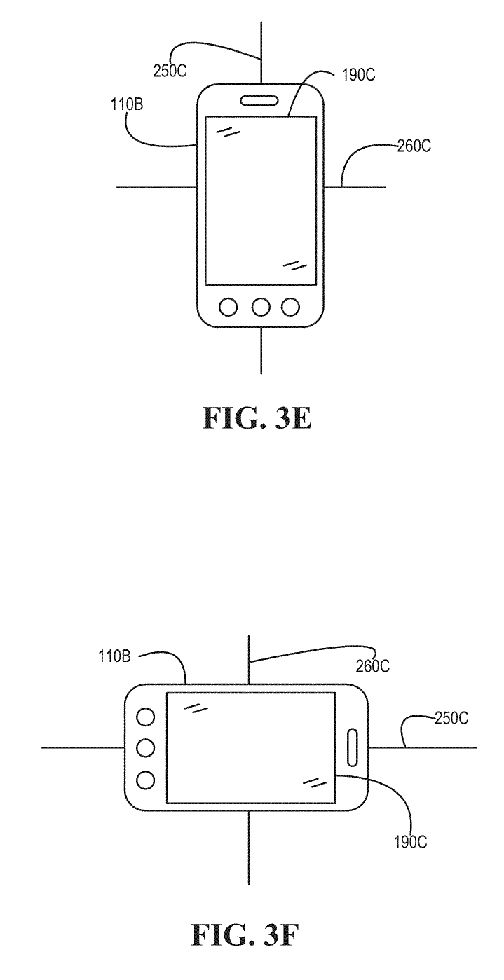

Turning now to FIGS. 3A-3F, example display devices are illustrated, according to one or more embodiments. With reference to FIG. 3A, display device 190A may be in a landscape mode. In one example, louvers 230 may absorb, diffuse, and/or obscure at least a portion of light emissions of display device 190A when a viewing angle is less than the threshold angle θ_{T} or greater than 180-θ_{T} with respect to axis 260A. For instance, a person may not be able to decipher information conveyed from display device 190A when a viewing angle is less than the threshold angle θ_{T} or greater than 180 -θ_{T} with respect to axis 260A. In another example, information conveyed via pixels 220 may be decipherable by a person when a viewing angle is greater than the threshold angle θ_{T} and less than 180 -θ_{T} with respect to axis 260A.

With reference to FIG. 3B, display device 190A may be in a portrait mode. In one example, louvers 240 may absorb, diffuse, and/or obscure at least a portion of light emissions of display device 190A when a viewing angle is less than the threshold angle ϕ_{T} or greater than 180-ϕ_{T} with respect to axis 250A. For instance, a person may not be able to decipher information conveyed from display device 190A when a viewing angle is less than the threshold angleϕ_{T} or greater than 180-_{T} with respect to axis 250A. In another example, information conveyed via pixels 220 may be decipherable by a person when a viewing angle is greater than the threshold angle ϕ_{T} and less than 180-ϕ_{T} with respect to axis 250A.

In one or more embodiments, with reference to either of FIGS. 3A and 3B, louvers 230 may absorb, diffuse, and/or obscure at least a portion of light emissions of display device 190A, and louvers 240 may absorb, diffuse, and/or obscure at least another portion of light emissions of display device 190A. For example, louvers 230 may absorb, diffuse, and/or obscure at least a portion of light emissions of display device 190A when a viewing angle is less than the threshold angle θ_{T} or greater than 180 -θ_{T} with respect to axis 260A, and louvers 240 may absorb, diffuse, and/or obscure at least another portion of light emissions of display device 190A when a viewing angle is less than the threshold angle ϕ_{T} or greater than 180-ϕ_{T} with respect to axis 250A. For instance, a person may not be able to decipher information conveyed from display device 190A when a viewing angle is less than the threshold angle θ_{T} or greater than 180 -θ_{T} with respect to axis 260A and/or when a viewing angle is less than the threshold angle ϕ_{T} or greater than 180-_{T} with respect to axis 250A.

With reference to FIG. 3C, display device 190B may be in a portrait mode. In one or more embodiments, an IHS 110A (e.g., a tablet computing device) may include display device 190B. In one example, louvers 230 may absorb, diffuse, and/or obscure at least a portion of light emissions of display device 190B when a viewing angle is less than the threshold angle θ_{T} or greater than 180 -θ_{T} with respect to axis 260B. For instance, a person may not be able to decipher information conveyed from display device 190B when a viewing angle is less than the threshold angle θ_{T} or greater than 180 -θ_{T} with respect to axis 260B. In another example, information conveyed via pixels 220 may be decipherable by a person when a viewing angle is greater than the threshold angle θ_{T} and less than 180 -θ_{T} with respect to axis 260B.

With reference to FIG. 3D, display device 190B may be in a landscape mode. In one example, louvers 240 may absorb, diffuse, and/or obscure at least a portion of light emissions of display device 190B when a viewing angle is less than the threshold angle ϕ_{T} or greater than 180 -ϕ_{T} with respect to axis 250B. For instance, a person may not be able to decipher information conveyed from display device 190B when a viewing angle is less than the threshold angle ϕ_{T} or greater than 180-_{T} with respect to axis 250B. In another example, information conveyed via pixels 220 may be decipherable by a person when a viewing angle is greater than the threshold angle ϕ_{T} and less than 180-_{T} with respect to axis 250B.

In one or more embodiments, with reference to either of FIGS. 3C and 3D, louvers 230 may absorb, diffuse, and/or obscure at least a portion of light emissions of display device 190B, and louvers 240 may absorb, diffuse, and/or obscure at least another portion of light emissions of display device 190B. For example, louvers 230 may absorb, diffuse, and/or obscure at least a portion of light emissions of display device 190B when a viewing angle is less than the threshold angle θ_{T} or greater than 180 -θ_{T} with respect to axis 260B, and louvers 240 may absorb, diffuse, and/or obscure at least another portion of light emissions of display device 190B and a viewing angle is less than the threshold angle ϕ_{T} or greater than 180-_{T} with respect to axis 250B. For instance, a person may not be able to decipher information conveyed from display device 190B when a viewing angle is less than the threshold angle θ_{T} or greater than 180 -θ_{T} with respect to axis 260B and/or when a viewing angle is less than the threshold angle ϕ_{T} or greater than 180-_{T} with respect to axis 250B.

With reference to FIG. 3E, display device 190C may be in a portrait mode. In one or more embodiments, an IHS 110B (e.g., a wireless telephone, a smart phone, a PDA, a digital music player, etc.) may include display device 190C. In one example, louvers 230 may absorb, diffuse, and/or obscure at least a portion of light emissions of display device 190C when a viewing angle is less than the threshold angle θ_{T} or greater than 180 -θ_{T} with respect to axis 260C. For instance, a person may not be able to decipher information conveyed from display device 190C when a viewing angle is less than the threshold angle θ_{T} or greater than 180 -θ_{T} with respect to axis 260C. In another example, information conveyed via pixels 220 may be decipherable by a person when a viewing angle is greater than the threshold angle θ_{T} and less than 180 -θ_{T} with respect to axis 260C.

With reference to FIG. 3F, display device 190C may be in a landscape mode. In one example, louvers 240 may absorb, diffuse, and/or obscure at least a portion of light emissions of display device 190C when a viewing angle is less than the threshold angle ϕ_{T} or greater than 180 -ϕ_{T} with respect to axis 250C. For instance, a person may not be able to decipher information conveyed from display device 190C when a viewing angle is less than the threshold angle ϕ_{T} or greater than 180-_{T} with respect to axis 250C. In another example, information conveyed via pixels 220 may be decipherable by a person when a viewing angle is greater than the threshold angle ϕ_{T} and less than 180-_{T} with respect to axis 250C.

In one or more embodiments, with reference to either of FIGS. 3E and 3F, louvers 230 may absorb, diffuse, and/or obscure at least a portion of light emissions of display device 190C, and louvers 240 may absorb, diffuse, and/or obscure at least another portion of light emissions of display device 190C. For example, louvers 230 may absorb, diffuse, and/or obscure at least a portion of light emissions of display device 190C when a viewing angle is less than the threshold angle θ_{T} or greater than 180 -θ_{T} with respect to axis 260C, and louvers 240 may absorb, diffuse, and/or obscure at least another portion of light emissions of display device 190C when a viewing angle is less than the threshold angle ϕ_{T} or greater than 180-_{T} with respect to axis 250C. For instance, a person may not be able to decipher information conveyed from display device 190C when a viewing angle is less than the threshold angle θ_{T} or greater than 180 -θ_{T} with respect to axis 260C and/or when a viewing angle is less than the threshold angle ϕ_{T} or greater than 180-ϕ_{T} with respect to axis 250C.

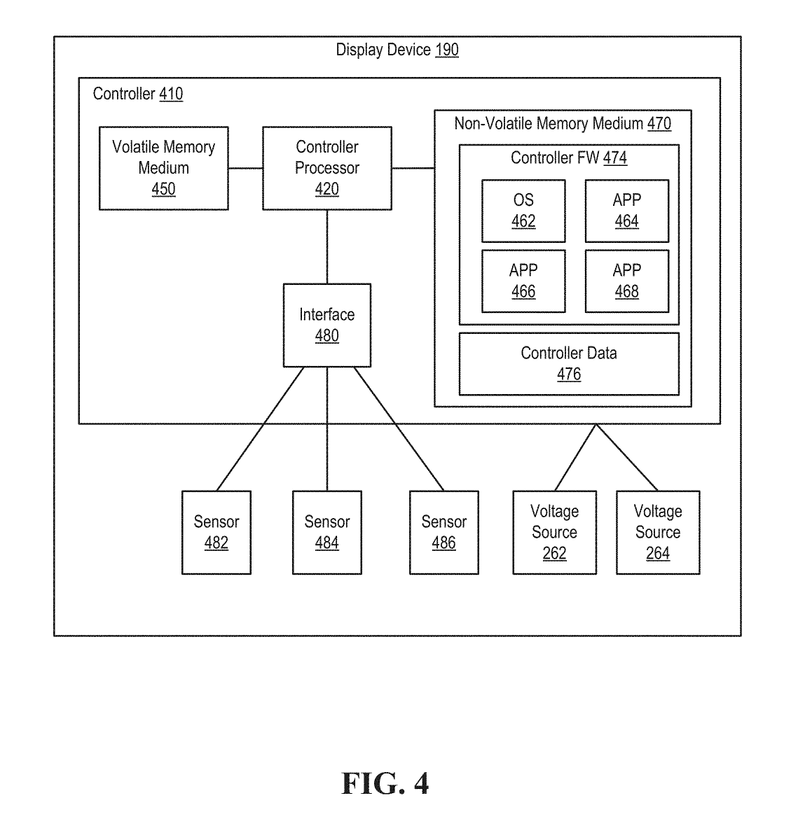

Turning now to FIG. 4, an example of a controller and sensors is illustrated, according to one or more embodiments. As shown, a controller may include a controller processor 420, a volatile memory medium 450, a non-volatile memory medium 470, and an interface 480. As illustrated, non-volatile memory medium 474 may include an controller FW 474, which may include an OS 462 and APPs 464-468, and may include controller data 476. For example, OS 462 may be or include a real time operating system (RTOS).

In one or more embodiments, one or more of OS 462 and APPs 464-468 may include processor instructions executable by controller processor 420. In one example, controller processor 420 may execute processor instructions of one or more of OS 462 and APPs 464-468 via non-volatile memory medium 470. In another example, one or more portions of the processor instructions of the one or more of OS 462 and APPs 464-468 may be transferred to volatile memory medium 450, and controller processor 420 may execute the one or more portions of the processor instructions of the one or more of OS 462 and APPs 464-468 via volatile memory medium 450.

In one or more embodiments, controller processor 420 may utilize controller data 476. In one example, controller processor 420 may utilize controller data 476 via non-volatile memory medium 470. In another example, one or more portions of controller data 476 may be transferred to volatile memory medium 450, and controller processor 420 may utilize controller data 476 via volatile memory medium 450.

As illustrated, display device 190 may include controller 410 and one or more of sensors 482-486. In one or more embodiments, one or more of sensors 482-486 may be coupled to controller 410. For example, one or more of sensors 482-486 may be coupled to an interface 480 of controller 410. In one or more embodiments, interface 480 may be or include a sensor hub. In one or more embodiments, interface 480 may include one or more of an I²C interface, a SPI interface, a USB interface, a general purpose input/output (GPIO) interface, and a universal asynchronous receiver-transmitter (UART) interface, among others. In one or more embodiments, sensors 482-486 may include one or more structures and/or functionalities as those described with reference to respective sensors 182-186. For example, controller processor 420 may receive data from one or more of sensors 482-486. For instance, controller processor 420 may receive data from one or more of sensors 482-486 via interface 480.

In one or more embodiments, controller 410 may be coupled to IHS 110. For example, controller 410 may receive and/or provide information from and/or to IHS 110. In one or more embodiments, controller 410 may control louvers 230 and 240 based on information received from one or more of sensors 482-486 and IHS 110. As shown, voltage sources 262 and 264 may be coupled to controller 410. In one or more embodiments, one or more of controller 410 and controller 420 may control one or more of voltage sources 262 and 264. In one or more embodiments, one or more of IHS 110 and processor 120 may control one or more of voltage sources 262 and 264 via one or more of controller 410 and controller 420.

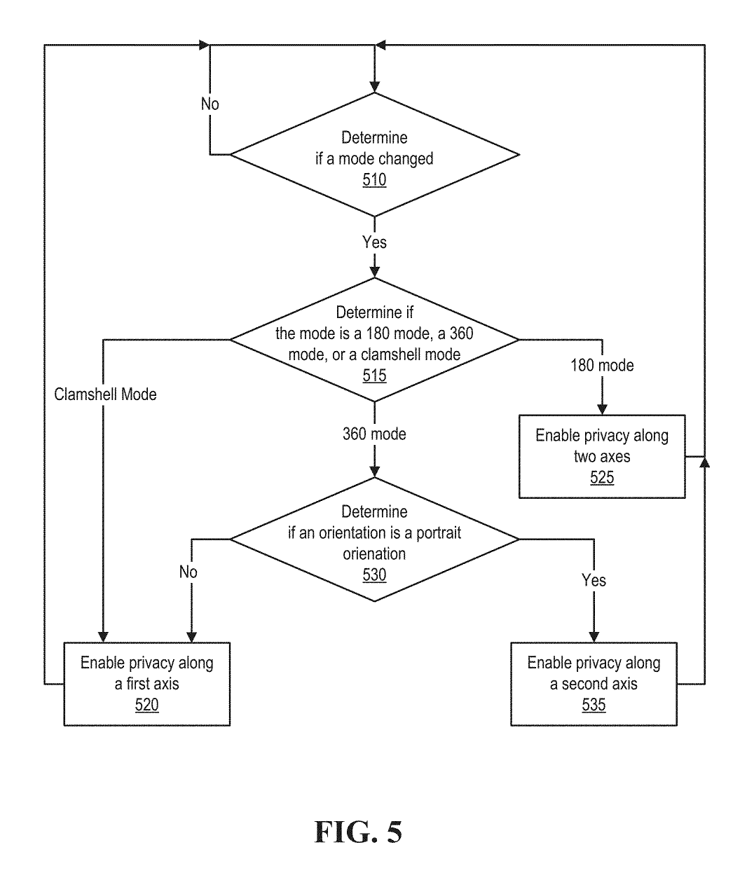

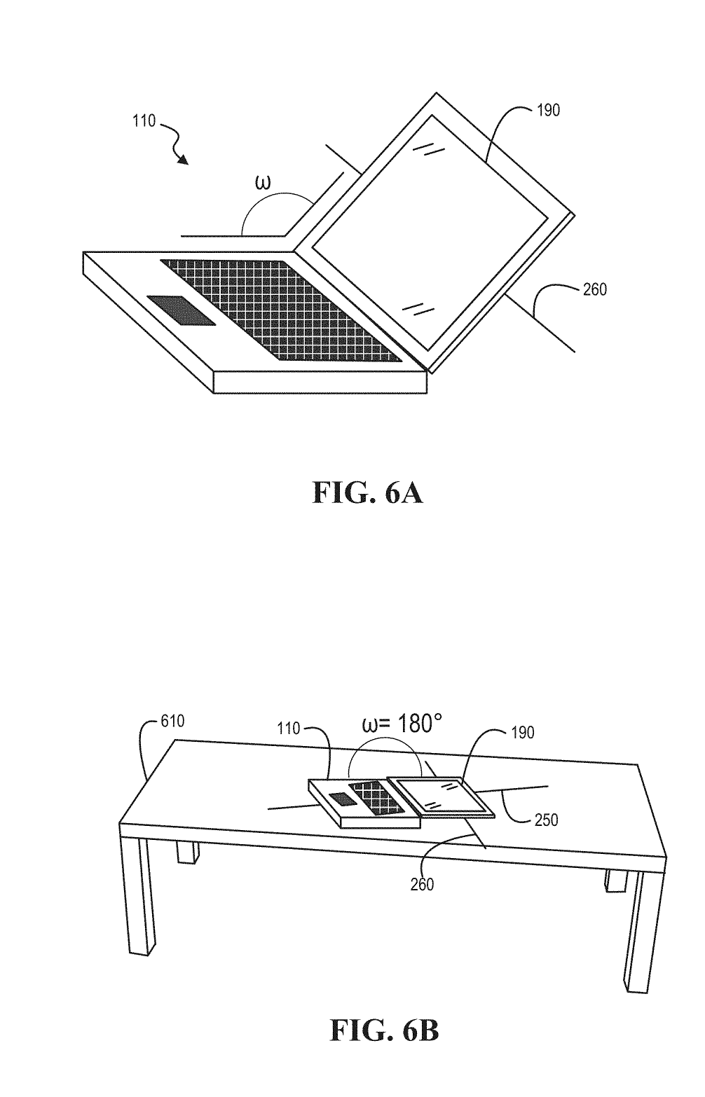

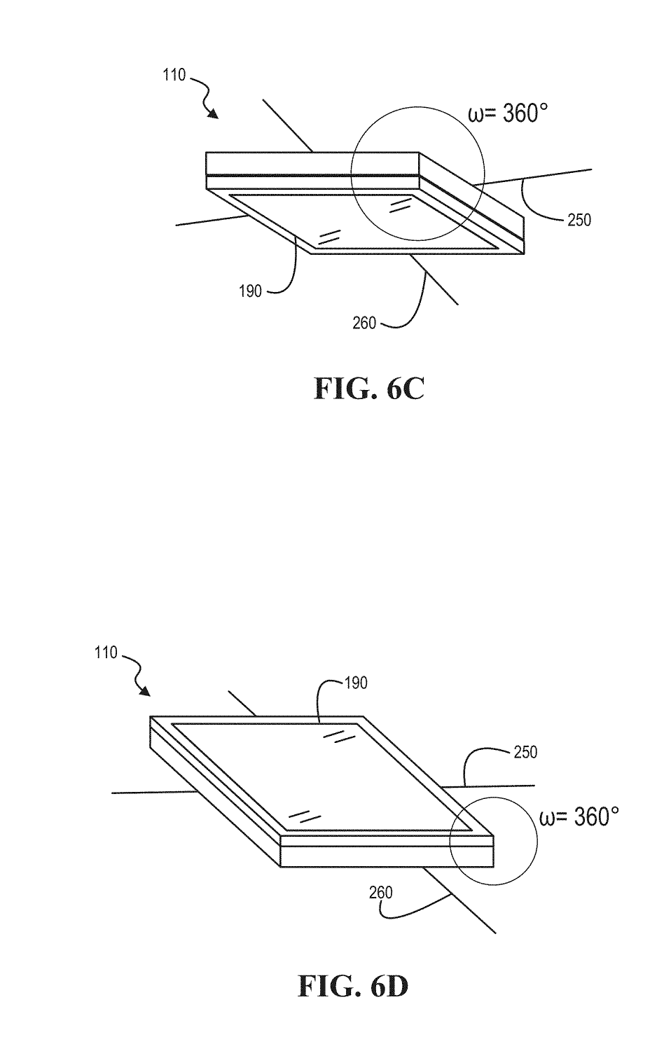

Turning now to FIG. 5, an example of a method of enabling privacy of a display device is illustrated, according to one or more embodiments. At 510, it may be determined if a mode has changed. For example, IHS 110 may determine if a mode has changed. In one instance, processor 120 may receive an interrupt that indicates the mode change. In another instance, IHS 110 may receive user input that indicates the mode change. If the mode has not changed, the method may return to 510, according to one or more embodiments. If the mode has changed, it may be determined if the mode is a “180 mode”, a “360 mode”, or a “clamshell mode”, at 515. If the mode is the mode is the clamshell mode, privacy along a first axis may be enabled, at 520. For example, FIG. 6A illustrates IHS 110 in the clamshell mode, and privacy along axis 260 may be enabled. In one or more embodiments, the method may proceed to 510. In one or more embodiments, the user input may be received via a software interface of IHS 110. For example, the user input may be received via a graphical user interface of IHS 110. In one or more embodiments, the user input may be received via a physical switch of IHS 110. For example, the user input may be received via a physical push button of IHS 110.

If the mode is the 180 mode, privacy along two axes may be enabled, at 525. For example, FIG. 6B illustrates IHS 110 in the 180 mode, and privacy along axes 250 and 260 may be enabled. In one instance, IHS 110 may be lying flat on a table 610. In another instance, IHS 110 may be lying substantially flat on a hand or lap of a person. In one or more embodiments, the method may proceed to 510. If the mode is the 360 mode, it may be determined if an orientation of display device 190 is a portrait orientation, at 530. If the orientation is not the portrait orientation, privacy along the first axis may be enabled, at 520. In one example, FIG. 6C illustrates an example of IHS 110 in a 360 mode. In another example, FIG. 6D illustrates another example of IHS 110 in a 360 mode. In one or more embodiments, the method may proceed to 510. If the orientation is the portrait orientation, privacy along a second axis may be enabled, at 535.

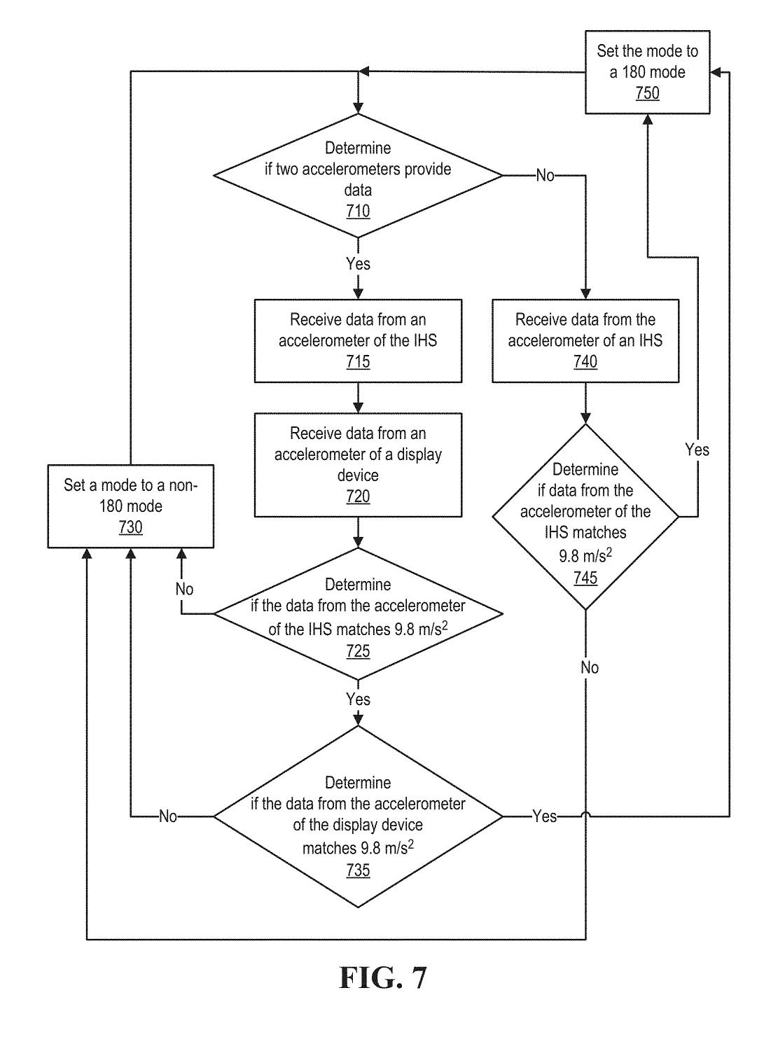

Turning now to FIG. 7, an example of a method of determining a 180 mode is illustrated, according to one or more embodiments. At 710, it may be determined if two accelerometers provide data. In one or more embodiments, determining if two accelerometers provide data may include determining if two accelerometers are present. In one or more embodiments, determining if two accelerometers provide data may include determining if two accelerometers are communicatively coupled to processor 120. If the two accelerometers provide data, data from an accelerometer of IHS 110 may be received, at 715. For example, processor 120 may receive data from sensor 182 (e.g., an accelerometer) may be received. At 720, data from an accelerometer of a display device may be received. For example, processor 120 may receive data from sensor 482 (e.g., an accelerometer). For instance, processor 120 may receive data from sensor 482 may be received via controller processor 420.

At 725, it may be determined if the data from the accelerometer of IHS 110 matches 9.8 m/s². For example, determining if the data from the accelerometer of IHS 110 matches 9.8 m/s² may include determining if the data from the accelerometer of IHS 110 matches a typical acceleration of gravity. In one or more embodiments, determining a match may include determining if data is within a tolerance. For example, the tolerance may include plus or minus five percent (5%). If the data from the accelerometer of IHS 110 does not match 9.8 m/s², a mode of non-180 mode may be set, at 730. In one or more embodiments, the method may proceed to 710. If the data from the accelerometer of IHS 110 matches 9.8 m/s², it may be determined if the data from the accelerometer of display device 190 matches 9.8 m/s², at 735. For example, determining if the data from the accelerometer of display device 190 matches 9.8 m/s² may include determining if the data from the accelerometer of display device 190 matches a typical acceleration of gravity. In one or more embodiments, determining a match may include determining if data is within a tolerance. For example, the tolerance may include plus or minus five percent (5%).

If the data from the accelerometer of display device 190 does not match 9.8 m/s², the mode of non-180 mode may be set, at 730. In one or more embodiments, the method may proceed to 710. If the data from the accelerometer of display device 190 matches 9.8 m/s², the mode may be set to the 180 mode, at 750. In one or more embodiments, the method may proceed to 710. If two accelerometers do not provide data, data from the accelerometer of IHS 110 may be received, at 740. For example, processor 120 may receive data from sensor 182 (e.g., an accelerometer) may be received.

At 745, it may be determined if the data from the accelerometer of IHS 110 matches 9.8 m/s². For example, determining if the data from the accelerometer of IHS 110 matches 9.8 m/s² may include determining if the data from the accelerometer of IHS 110 matches a typical acceleration of gravity. In one or more embodiments, determining a match may include determining if data is within a tolerance. For example, the tolerance may include plus or minus five percent (5%). If the data from the accelerometer of IHS 110 does not match 9.8 m/s², a mode of non-180 mode may be set, at 730. In one or more embodiments, the method may proceed to 710. If the data from the accelerometer of IHS 110 matches 9.8 m/s², the mode may be set to the 180 mode, at 750. In one or more embodiments, the method may proceed to 710.

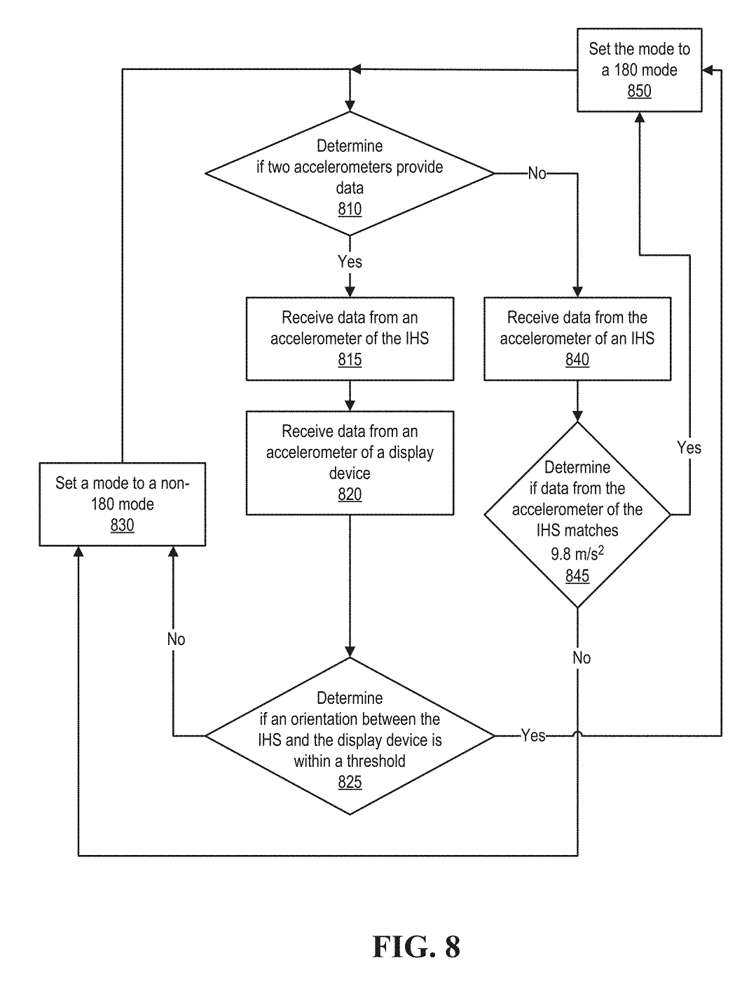

Turning now to FIG. 8, an example of a method of utilizing vectors in determining a 180 mode is illustrated, according to one or more embodiments. At 810, it may be determined if two accelerometers provide data. In one or more embodiments, determining if two accelerometers provide data may include determining if two accelerometers are present. In one or more embodiments, determining if two accelerometers provide data may include determining if two accelerometers are communicatively coupled to processor 120. If the two accelerometers provide data, data from an accelerometer of IHS 110 may be received, at 815. For example, processor 120 may receive data from sensor 182 (e.g., an accelerometer) may be received. At 820, data from an accelerometer of a display device may be received. For example, processor 120 may receive data from sensor 482 (e.g., an accelerometer). For instance, processor 120 may receive data from sensor 482 may be received via controller processor 420.

At 825, it may be determined if an orientation between IHS 110 and display 190 is within a threshold. For example, the orientation between IHS 110 and display 190 may be represented by an angle ω, illustrated in FIG. 6A. In one or more embodiments, determining if the orientation between IHS 110 and display 190 is within the threshold may include utilizing the data from the accelerometer of IHS 110 as a first vector and utilizing the data from the accelerometer of display device 190 as a second vector. For example, determining if the orientation between IHS 110 and display 190 is within the threshold may include determining if an angle between the first vector and the second vector is less than or equal to a threshold angle. For instance, determining if an angle, ω, between the first vector and the second vector is less than or equal to a threshold angle, ω_{Threshold}, may include determining:

$$ω = {cos}^{- 1} ( \frac{\vec{{X}_{1}} \cdot \vec{{X}_{2}}}{‖ \vec{{X}_{1}} ‖ \cdot ‖ \vec{{X}_{2}} ‖} ) \leq {ω}_{Threshold}$$

If the orientation between IHS 110 and display 190 is not within the threshold (e.g., ω is not less than or equal to ω_{Threshold}), a mode of a non-180 mode may be set, at 830. If the orientation between IHS 110 and display 190 is within the threshold (e.g., ω is less than or equal to ω_{Threshold}), a mode of a 180 mode may be set, at 850. In one or more embodiments, the method may proceed to 810. If two accelerometers do not provide data, data from the accelerometer of IHS 110 may be received, at 840. For example, processor 120 may receive data from sensor 182 (e.g., an accelerometer) may be received.

At 845, it may be determined if the data from the accelerometer of IHS 110 matches 9.8 m/s². For example, determining if the data from the accelerometer of IHS 110 matches 9.8 m/s² may include determining if the data from the accelerometer of IHS 110 matches a typical acceleration of gravity. In one or more embodiments, determining a match may include determining if data is within a tolerance. For example, the tolerance may include plus or minus five percent (5%). If the data from the accelerometer of IHS 110 does not match 9.8 m/s², a mode of non-180 mode may be set, at 830. In one or more embodiments, the method may proceed to 810. If the data from the accelerometer of IHS 110 matches 9.8 m/s², the mode may be set to the 180 mode, at 850. In one or more embodiments, the method may proceed to 810.

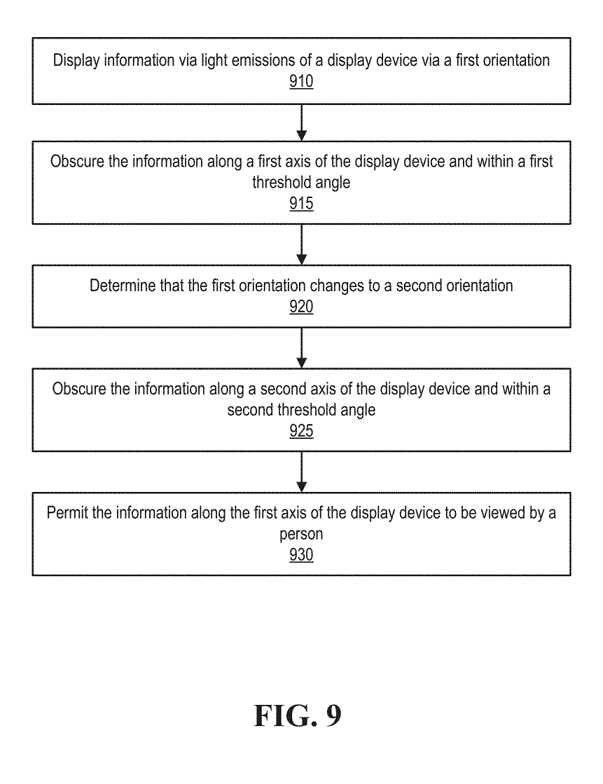

Turning now to FIG. 9, an example of a method of controlling light emissions of a display device is illustrated, according to one or more embodiments. At 910, information may be displayed via light emissions of a display device via a first orientation. In one example, display device 190A may display information may be displayed via light emissions via a first orientation, as illustrated in FIG. 3A. In a second example, display device 190B may display information may be displayed via light emissions via a first orientation, as illustrated in FIG. 3C. In another example, display device 190C may display information may be displayed via light emissions via a first orientation, as illustrated in FIG. 3E.

At 915, the information along a first axis of the display device and within a first threshold angle may be obscured. In one example, the information along axis 260A of display device 190A and within θ_{T} may be obscured. In a second example, the information along axis 260B of display device 190B and within θ_{T} may be obscured. In another example, the information along axis 260C of display device 190C and within θ_{T} may be obscured. In one or more embodiments, an anisotropic material, of the display device, may obscure the information along the first axis of the display device and within the first threshold angle. For example, the anisotropic material may include louvers 230. In one instance, louvers 230 may be orthogonal to the first axis. In another instance, louvers 230 may be substantially orthogonal to the first axis (e.g., within a few degrees of orthogonal to the first axis).

At 920, it may be determined that the first orientation changes to a second orientation. In one example, it may be determined that the first orientation of display device 190A, illustrated, in FIG. 3A, changes to a second orientation of display device 190A, illustrated in FIG. 3B. In a second example, it may be determined that the first orientation of display device 190B, illustrated, in FIG. 3C, changes to a second orientation of display device 190B, illustrated in FIG. 3D. In a third example, it may be determined that the first orientation of display device 190C, illustrated, in FIG. 3E, changes to a second orientation of display device 190C, illustrated in FIG. 3F. In another example, it may be determined that the first orientation of display device 190 changes to a second orientation of display device 190, illustrated in FIG. 6B. In one or more embodiments, determining that the first orientation changes to the second orientation may include receiving data from at least one of an electronic accelerometer, an electronic gyroscope, and an electronic magnetometer, among others, and determining that the first orientation changes to the second orientation based at least on the data from the at least one of the electronic accelerometer, the electronic gyroscope, and the electronic magnetometer, among others. In one example, sensors 182-186 may include the electronic accelerometer, the electronic gyroscope, and the electronic magnetometer, respectively. In another example, sensors 482-486 may include the electronic accelerometer, the electronic gyroscope, and the electronic magnetometer, respectively.

At 925, the information along a second axis of the display device and within a second threshold angle may be obscured. In one example, the information along axis 250A of display device 190A and within ϕ_{T} may be obscured. In a second example, the information along axis 250B of display device 190B and within ϕ_{T} may be obscured. In a third example, the information along axis 250C of display device 190C and within ϕ_{T} may be obscured. In another example, the information along axis 250 of display device 190 and within ϕ_{T} may be obscured, illustrated in FIG. 6A. In one or more embodiments, an anisotropic material may obscure the information along the second axis of the display device and within the second threshold angle. For example, the anisotropic material may include louvers 240. In one instance, louvers 240 may be orthogonal to the second axis. In another instance, louvers 240 may be substantially orthogonal to the second axis (e.g., within a few degrees of orthogonal to the second axis). In one or more embodiments, obscuring the information along the second axis of the display device and within the second threshold angle may be performed in response to determining that the first orientation changes to the second orientation.

At 930, the information along the first axis of the display device may be permitted to be viewed by a person. In one example, the information along axis 260A of display device 190A, illustrated in FIG. 3B, may be permitted to be viewed by the person. In one instance, the anisotropic material may permit the information along axis 260A of display device 190A to be viewed by the person. In another instance, louvers 230 may permit the information along axis 260A of display device 190A to be viewed by the person. In a second example, the information along axis 260B of display device 190B, illustrated in FIG. 3D, may be permitted to be viewed by the person. In one instance, the anisotropic material may permit the information along axis 260B of display device 190B to be viewed by the person. In another instance, louvers 230 may permit the information along axis 260B of display device 190B to be viewed by the person. In another example, the information along axis 260C of display device 190C, illustrated in FIG. 3F, may be permitted to be viewed by the person. In one instance, the anisotropic material may permit the information along axis 260C of display device 190C to be viewed by the person. In another instance, louvers 230 may permit the information along axis 260C of display device 190C to be viewed by the person. In one or more embodiments, permitting the information along the first axis of the display device to be viewed by the person may be performed in response to determining that the first orientation changes to the second orientation.

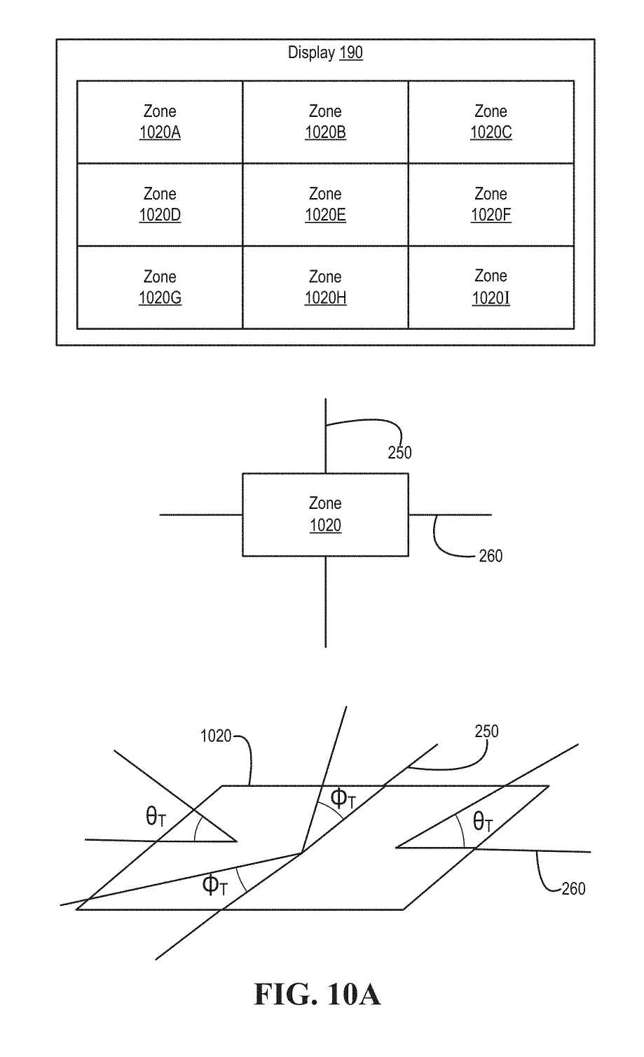

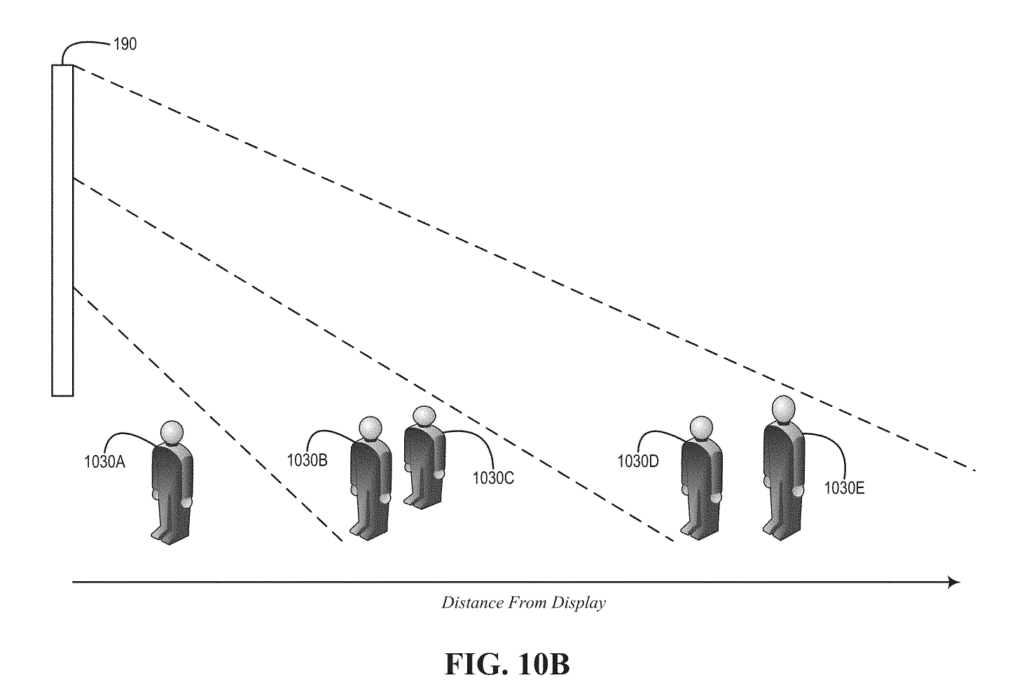

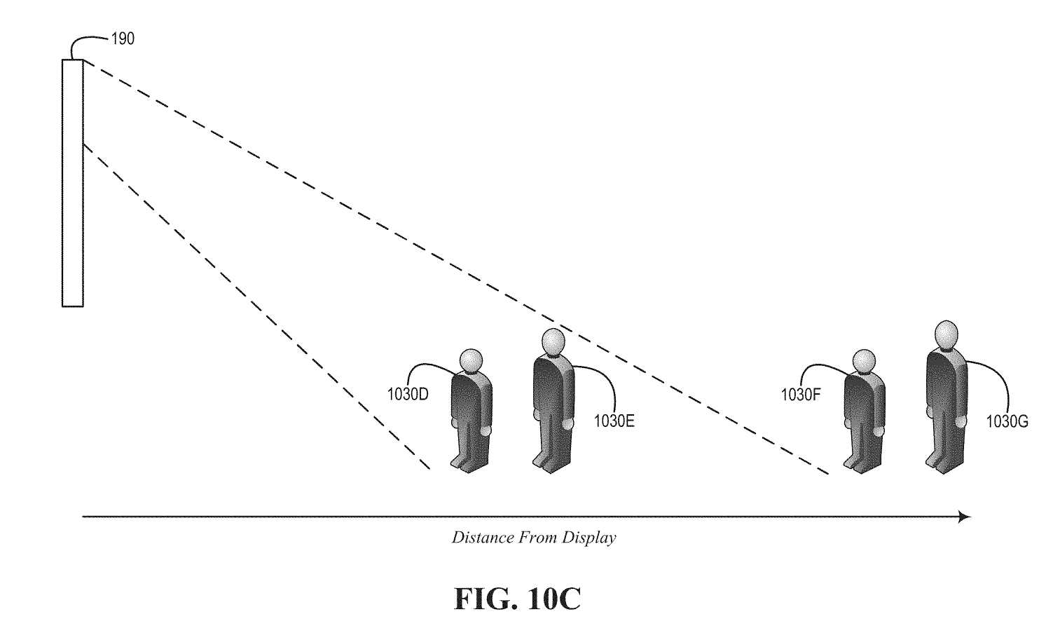

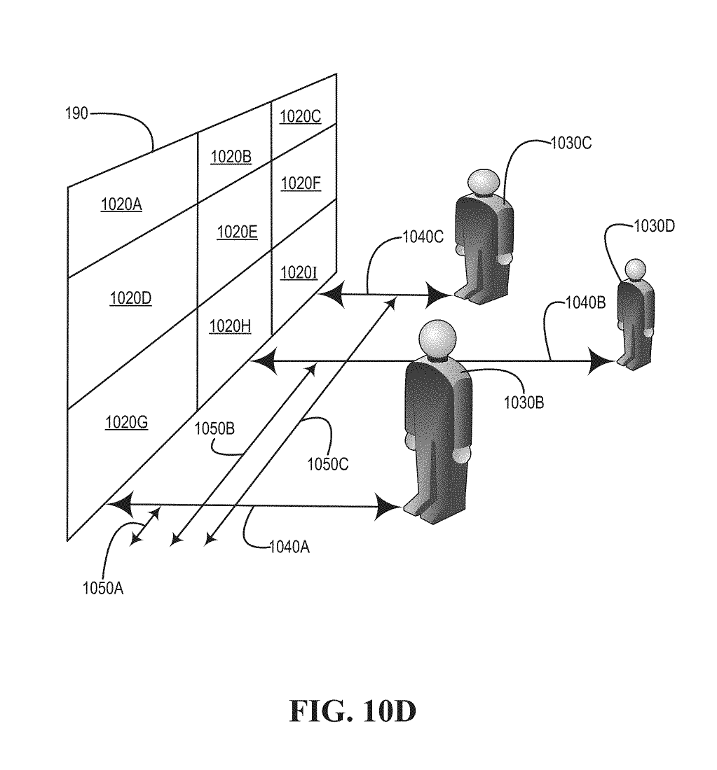

Turning now to FIG. 10A, a display with multiple zones is illustrated, according to one or more embodiments. As shown, display 190 may be sectioned into zones 1020A-1020I. In one or more embodiments, zone 1020 may function as display 190, described above. For example, zone 1020 may function as a display 190 within display 190. For instance, zone 1020 may be or include a virtual display 190 of physical display 190.

In one or more embodiments, light emissions of a zone 1020 may be controlled. In one example, an anisotropic material, of display device 190, may obscure the information along a first axis (e.g., axis 260) of a zone 1020 and within a first threshold angle. In one instance, the anisotropic material may include louvers 230. In one instance, louvers 230 may be orthogonal to the first axis. In another instance, louvers 230 may be substantially orthogonal to the first axis (e.g., within a few degrees of orthogonal to the first axis). In another example, the anisotropic material, of display device 190, may obscure the information along a second axis (e.g., axis 250) of zone 1020 and within a second threshold angle. In one instance, the anisotropic material may include louvers 240. In one instance, louvers 240 may be orthogonal to the second axis. In another instance, louvers 240 may be substantially orthogonal to the second axis (e.g., within a few degrees of orthogonal to the second axis). Although zone 1020 is shown to be rectangular, zone 1020 may be or include any shape, according to one or more embodiments.

In one or more embodiments, zone 1020 may be for example and/or for illustrative purposes. For example, zone 1020 may not actually physically exist within display device 190. In one or more embodiments, zone 1020 may be configured and/or implemented via multiple pixels and/or louvers 230 and/or 240. As illustrated, the threshold angle ϕ_{T} or may be with reference to an axis 250, and the threshold angle θ_{T} may be with reference to an axis 260.

In one or more embodiments, louvers 230 and 240 of zone 1020 may form multiple apertures. In one example, the apertures may be directed. In another example, a centroid and/or a barycenter of the apertures may be determined. In one instance, the centroid and/or the barycenter may determine one or more positions where information from zone 1020 may be obscured from viewing. In another instance, the centroid and/or the barycenter may determine one or more positions where information from zone 1020 may be unobscured from viewing. In one or more embodiments, a display aperture may be smaller near a perimeter of display 190. For example, a centroid of apertures may be larger near the perimeter of display 190, which may cause the display aperture may be smaller near the perimeter of display 190.

Turning now to FIG. 10B, an example of users of a display is illustrated, according to one or more embodiments. As shown, users (e.g., people) 1030A-1030E may utilize display 190. In one or more embodiments, a user 1030 may utilize one or more zones 1020 based at least on a distance from a display. In one example, user 1030A may utilize one or more of zones 1020G-1020I, based at least on a distance from display 190. In a second example, users 1030B and 1030C may utilize one or more of zones 1020D-1020F, based at least on a distance from display 190. In another example, users 1030D and 1030E may utilize one or more of zones 1020A-1020C, based at least on a distance from display 190.

Turning now to FIG. 10C, an example of users that may not utilize a display is illustrated, according to one or more embodiments. In one or more embodiments, one or more users 1030 may not utilize a display, based at least on a distance from the display. For example, users 1030F and 1030G may not be able to utilize display 190, based at least on a distance from display 190. For instance, zones 1020A-1020I may obscure light emissions from users 1030F and 1030G. As previously described, users 1030D and 1030E may utilize one or more of zones 1020A-1020C, based at least on a distance from display 190.

Turning now to FIG. 10D, another example of users of a display is illustrated, according to one or more embodiments. As shown, user 1030B may be at a distance 1040A from display 190, user 1030D may be at a distance 1040B from display 190, and user 1030C may be at a distance 1040C from display 190. As illustrated, user 1030B may be at a distance 1050A from a reference side (e.g., a left edge) of display 190, user 1030D may be at a distance 1050B from the reference side of display 190, and user 1030C may be at a distance 1050C from the reference side of display 190. In one example, display 190 may obscure information of one or more of zones 1020A-1020C and 1020E-1020I from 1030B. For instance, display 190 may obscure information of one or more of zones 1020A-1020C and 1020E-1020I from a viewer at position 1040A and 1050A. In a second example, display 190 may obscure information of one or more of zones 1020A, 1020C-1020I from user 1030D. For instance, display 190 may obscure information of one or more of zones 1020A, 1020C-1020I from a viewer at position 1040B and 1050B. In another example, display 190 may obscure information of one or more of zones 1020A-1020E and 1020G-1020I from user 1030C. For instance, display 190 may obscure information of one or more of zones 1020A-1020E and 1020G-1020I from a viewer at position 1040C and 1050C.

In one or more embodiments, display 190 may be configured to permit various zones 1020 to be viewed (e.g., unobscured). In one example, user 1030B may view one or more of zones 1020D-1020F. For instance, one or more of zones 1020D-1020F may be unobscured from a viewer at position 1040A and 1050A. In a second example, user 1030D may view one or more of zones 1020A-1020C. For instance, one or more of zones 1020A-1020C may be unobscured from a viewer at position 1040B and 1050B. In a third example, user 1030B may view one or more of zones 1020D-1020F. For instance, one or more of zones 1020D-1020F may be unobscured from a viewer at position 1040C and 1050C. In a fourth example, user 1030B may view one or more of zones 1020A, 1020D, and 1020G. For instance, one or more of zones 1020A, 1020D, and 1020G may be unobscured from a viewer at position 1040A and 1050A. In a fifth example, user 1030D may view one or more of zones 1020B, 1020E, and 1020H. For instance, one or more of zones 1020B, 1020E, and 1020H may be unobscured from a viewer at position 1040B and 1050B. In another example, user 1030B may view one or more of zones 1020C, 1020F, and 1020I. For instance, one or more of zones 1020C, 1020F, and 1020I may be unobscured from a viewer at position 1040C and 1050C.

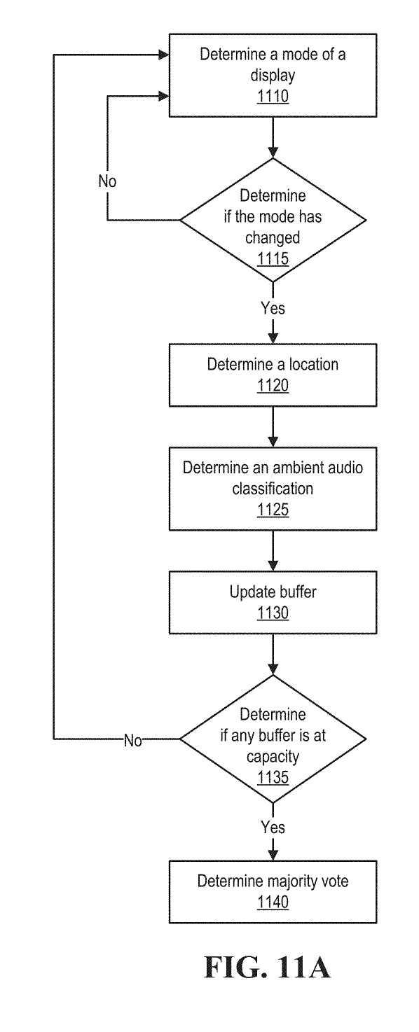

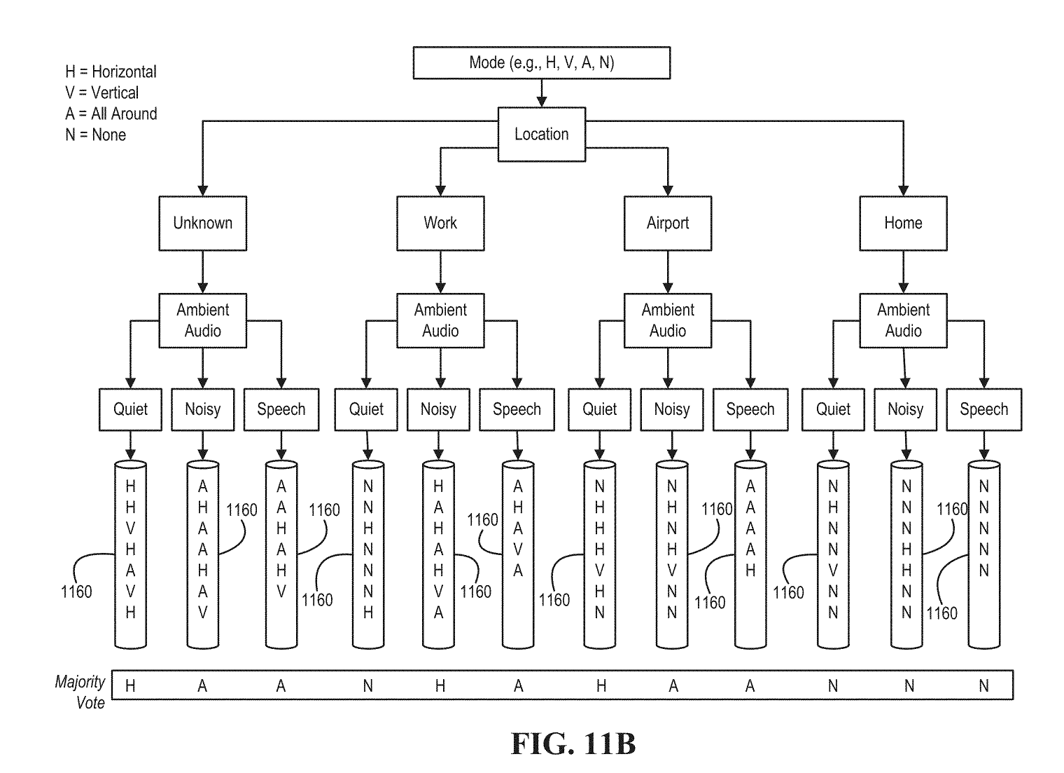

Turning now to FIG. 11A, an example of method of operating an information handling system is illustrated, according to one or more embodiments. At 1110, a mode of a display may be determined. For example, a mode of display 190 may be determined. For instance, the mode may include a 360 mode, a 180 mode, a landscape mode, a portrait mode, etc. In one or more embodiments, the mode of the display may obscure information along one or more axes. For example, the mode of the display may obscure information along one or more axes 250 and 260 of display 190.

At 1115, it may be determined if the mode of the display has changed. If the mode of the display has not changed, the method may proceed to 1110, according to one or more embodiments. If the mode of the display has changed, a location may be determined at 1120. In one example, the location may be a physical location. In one instance, the location may be received from user input. In a second instance, the location may be determined via a global positioning system (GPS) receiver device. In a third instance, the location may be determined via a WiFi access point (e.g., a physical location of the WiFi access point). In fourth instance, the location may be determined via a beacon (e.g., a WiFi beacon, a Bluetooth beacon, etc.). In another instance, the location may be determined via trilateration. In another example, the location may be a semantic location. For instance, the semantic location may be determined via a series of physical locations. In one or more embodiments, the location may include an “unknown” location, a “work” location, an “airport” location, and a “home” location, as illustrated in FIG. 11B.

At 1125, an ambient audio classification may be determined. In one or more embodiments, an ambient audio classification may include a “quiet” ambient audio classification, a “Noisy” ambient audio classification, and a “Speech” ambient audio classification, among others, as shown in FIG. 11B. Example ambient audio classifications with associated sound pressure levels are shown in Table1.

TABLE 1

| Ambient Audio Classification | Sound pressure level (dB) |
|---|---|
| Quiet | 10-30 |
| Speech | 40-60 |
| Noisy | 60-80 |
| Very Noisy | Above 80 |

At 1130, a buffer may be updated. For example, a buffer 1160 (FIG. 11B) may be updated. In one or more embodiments, the buffer may include a first-in, first-out data structure. For example, buffer 1160 may be or include a queue. At 1135, it may be determined if any buffer is at capacity. For example, it may be determined if any buffer 1160 is at capacity (e.g., full). If any buffer is at capacity, a majority vote may be determined, at 1140. Otherwise, the method may proceed to 1110, according to one or more embodiments. In one or more embodiments, the majority vote may be utilized in a machine learning process. For example, the machine learning process may determine a display mode to be utilized at a location based at least on ambient sounds. Although a majority vote machine learning process is described, any machine learning process and/or method may be utilized.

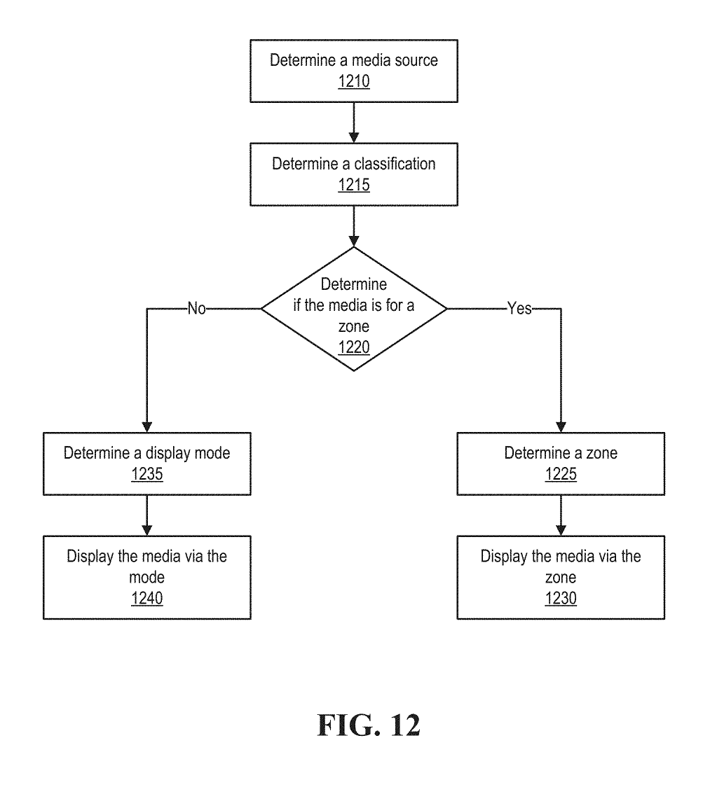

Turning now to FIG. 12, an example method of operating displays is illustrated, according to one or more embodiments. At 1210, a media source may be determined. For example, the media source may be or include a video, an image, or a document, among others. At 1215, a classification may be determined. For example, the classification may be or include “no restriction”, “restricted”, “internal use”, or “critical handling”, among others.

At 1220, it may be determined if the media is for a zone. In one or more embodiments, determining if the media is for a zone may be based at least on the media source and/or the media classification. If the media is for a zone, a zone may be determined at 1225. In one or more embodiments, determining the zone may be based at least on the media source and/or the media classification. For example, the determined zone may include a zone of zones 1020A-1020I. At 1230, the media may be displayed via the zone. For example, the media may be displayed via the zone determined at 1225. If the media is not for a zone, a display mode may be determined at 1235. In one or more embodiments, determining the display mode may be based at least on the media source and/or the media classification. For example, the mode may include a 360 mode, a 180 mode, a landscape mode, a portrait mode, etc. At 1240, the media may be displayed via the mode. For example, display 190 may display the media via the mode determined at 1235. In one or more embodiments, the mode determined at 1235 may be associated with a configuration that obscures information along one or more axes of the display. For example, the determined mode may obscure information along one or more of axes 250 and 260 of display 190.

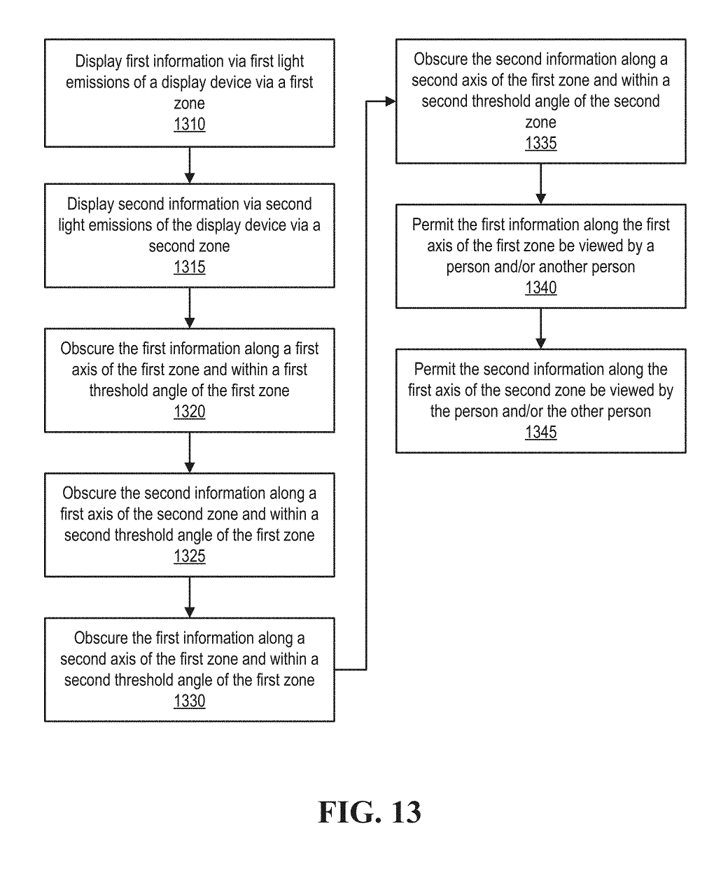

Turning now to FIG. 13, an example method of operating zones of a display is illustrated, according to one or more embodiments. At 1310, first information may be displayed via first light emissions of a display device and via a first zone. At 1315, second information may be displayed via second light emissions of the display device and via a second zone. In one or more embodiments, the second information may be different from the first information. At 1320, the first information may be obscured along a first axis of the first zone and within a first of the first zone and within a first threshold angle of the first zone. For example, the first information along axis 260 of zone 1020A and within θ_{T} may be obscured. In one or more embodiments, an anisotropic material, of the display device, may obscure the first information along the first axis of the first zone and within the first threshold angle of the first zone. For example, the anisotropic material may include louvers 230. In one instance, louvers 230 may be orthogonal to the first axis of the first zone. In another instance, louvers 230 may be substantially orthogonal to the first axis of the first zone (e.g., within a few degrees of orthogonal to the first axis of the first zone). In one or more embodiments, a portion of louvers 230 may be associated to zone 1020A. For example, a portion of louvers 230 may be associated to zone 1020A may be assigned to zone 1020A.

At 1325, the second information may be obscured along a first axis of the second zone and within a first of the second zone and within a first threshold angle of the second zone. For example, the second information along axis 260 of zone 1020F and within θ_{T} may be obscured. In one or more embodiments, an anisotropic material, of the display device, may obscure the second information along the first axis of the second zone and within the first threshold angle of the second zone. For example, the anisotropic material may include louvers 230. In one instance, louvers 230 may be orthogonal to the first axis of the second zone. In another instance, louvers 230 may be substantially orthogonal to the first axis of the second zone (e.g., within a few degrees of orthogonal to the first axis of the second zone). In one or more embodiments, a portion of louvers 230 may be associated to zone 1020F. For example, a portion of louvers 230 may be associated to zone 1020F may be assigned to zone 1020F. In one or more embodiments, the first threshold angle of the second zone may be different from or the same as the first threshold angle of the first zone.

At 1330, the first information along a second axis of the first zone and within a second threshold angle of the first zone may be obscured. For example, the first information along axis 250 of the first zone and within ϕ_{T} may be obscured. In one or more embodiments, an anisotropic material may obscure the information along the second axis of the first zone and within the second threshold angle of the first zone. For example, the anisotropic material may include louvers 240. In one instance, louvers 240 may be orthogonal to the second axis of the first zone. In another instance, louvers 240 may be substantially orthogonal to the second axis of the first zone (e.g., within a few degrees of orthogonal to the second axis of the first zone). In one or more embodiments, a portion of louvers 240 may be associated to zone 1020A. For example, a portion of louvers 240 may be associated to zone 1020A may be assigned to zone 1020A. In one or more embodiments, the first information along the second axis of the first zone and within the second threshold angle of the first zone may be obscured in response to determining a media type and/or a media classification.

At 1335, the second information along a second axis of the second zone and within a second threshold angle of the second zone may be obscured. For example, the second information along axis 250 of the second zone and within ϕ_{T} may be obscured. In one or more embodiments, an anisotropic material may obscure the information along the second axis of the second zone and within the second threshold angle of the second zone. For example, the anisotropic material may include louvers 240. In one instance, louvers 240 may be orthogonal to the second axis of the second zone. In another instance, louvers 240 may be substantially orthogonal to the second axis of the second zone (e.g., within a few degrees of orthogonal to the second axis of the second zone). In one or more embodiments, a portion of louvers 240 may be associated to zone 1020F. For example, a portion of louvers 240 may be associated to zone 1020F may be assigned to zone 1020F. In one or more embodiments, the second information along the second axis of the second zone and within the second threshold angle of the second zone may be obscured in response to determining a media type and/or a media classification. In one or more embodiments, the second threshold angle of the second zone may be different from or the same as the second threshold angle of the first zone.

At 1340, the first information along the first axis of the first zone may be permitted to be viewed by a person and/or another person. For example, the first information along axis 260 of the first zone may be permitted to be viewed by the person and/or the other person. At 1345, the second information along the first axis of the second zone may be permitted to be viewed by the person and/or another person. For example, the second information along axis 260 of the second zone may be permitted to be viewed by the person and/or the other person.

In one or more embodiments, one or more of the method and/or process elements and/or one or more portions of a method and/or processor elements may be performed in varying orders, may be repeated, or may be omitted. Furthermore, additional, supplementary, and/or duplicated method and/or process elements may be implemented, instantiated, and/or performed as desired, according to one or more embodiments. Moreover, one or more of system elements may be omitted and/or additional system elements may be added as desired, according to one or more embodiments.

In one or more embodiments, a memory medium may be and/or may include an article of manufacture. For example, the article of manufacture may include and/or may be a software product and/or a program product. For instance, the memory medium may be coded and/or encoded with processor-executable instructions in accordance with one or more flowcharts, systems, methods, and/or processes described herein to produce the article of manufacture. In one or more embodiments, one or more devices and/or one or more systems described herein may include circuitry that is configured in accordance with one or more flowcharts, systems, methods, and/or processes described herein. In one example, the circuitry may include a processor and/or a memory medium coded and/or encoded with processor-executable instructions in accordance with one or more flowcharts, systems, methods, and/or processes described herein. In another example, the circuitry may include other circuitry configured in accordance with one or more flowcharts, systems, methods, and/or processes described herein.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A display device, comprising:
a plurality of pixels that are configured to emit light;
an anisotropic material configured to obscure light emitted from the plurality of pixels along two axes of each of a plurality of zones of the display device; and
circuitry configured to:
display first information via first light emissions of the display device via a first zone of the plurality of zones;
display second information via second light emissions of the display device via a second zone of the plurality of zones;
obscure, via the anisotropic material, the first information along a first axis of the first zone and within a first threshold angle of the first zone;
obscure, via the anisotropic material, the second information along a first axis of the second zone and within a first threshold angle of the second zone;
obscure, via the anisotropic material, the first information along a second axis of the first zone and within a second threshold angle of the first zone; and
obscure, via the anisotropic material, the second information along a second axis of the second zone and within a second threshold angle of the second zone.

2. The display device of claim 1, wherein the circuitry is further configured to:
permit, via the anisotropic material, the first information along the first axis of the first zone to be viewed by at least one person.

3. The display device of claim 1,
wherein the circuitry is further configured to:
determine a media classification; and
wherein the circuitry obscures, via the anisotropic material, the first information along the second axis of the first zone and within the second threshold angle of the first zone in response to determining the media classification.

4. The display device of claim 1, wherein the anisotropic material includes a first plurality of strips, having a first height, associated with the first axis and a second plurality of strips, having a second height, associated with the second axis.

5. The display device of claim 4,
wherein the first plurality of strips and the second plurality of strips form apertures of the first zone; and
wherein a centroid of the apertures of the first zone determines one or more positions where the first information is obscured.

6. The display device of claim 4,
wherein the first information is displayed via a first portion of the first light emissions; and
wherein the first plurality of strips obscure the first portion of the first light emissions.

7. The display device of claim 1, wherein the second threshold angle of the second zone is different from the second threshold angle of the first zone.

8. A method, comprising:
a display device displaying first information via first light emissions of the display device via a first zone;
the display device displaying second information via second light emissions of the display device via a second zone;
an anisotropic material, of the display device, obscuring the first information along a first axis of the first zone and within a first threshold angle of the first zone;
the anisotropic material, of the display device, obscuring the second information along a first axis of the second zone and within a first threshold angle of the second zone;
the anisotropic material obscuring the first information along a second axis of the first zone and within a second threshold angle of the first zone; and
the anisotropic material obscuring the second information along a second axis of the second zone and within a second threshold angle of the second zone.

9. The method of claim 8, further comprising:
the anisotropic material permitting the first information along the first axis of the first zone to be viewed by at least one person.

10. The method of claim 8, wherein the anisotropic material obscuring the first information along the second axis of the first zone and within the second threshold angle of the first zone is performed in response to determining a media classification.

11. The method of claim 8, wherein the anisotropic material includes a first plurality of strips, having a first height, associated with the first axis and a second plurality of strips, having a second height, associated with the second axis.

12. The method of claim 11,
wherein the first plurality of strips and the second plurality of strips form apertures of the first zone; and
wherein a centroid of the apertures of the first zone determines one or more positions where the first information is obscured.

13. The method of claim 11,
wherein the first information is displayed via a first portion of the first light emissions; and
wherein the first plurality of strips obscure the first portion of the first light emissions.

14. The method of claim 8, wherein the second threshold angle of the second zone is different from the second threshold angle of the first zone.

15. An information handling system, comprising:
a display that includes a plurality of pixels that are configured to emit light and an anisotropic material configured to obscure light emitted from the pixels along two axes of the display device; and
circuitry configured to:
display first information via first light emissions of the display device via a first zone of the plurality of zones;
display second information via second light emissions of the display device via a second zone of the plurality of zones;
obscure, via the anisotropic material, the first information along a first axis of the first zone and within a first threshold angle of the first zone;
obscure, via the anisotropic material, the second information along a first axis of the second zone and within a first threshold angle of the second zone;
obscure, via the anisotropic material, the first information along a second axis of the first zone and within a second threshold angle of the first zone; and
obscure, via the anisotropic material, the second information along a second axis of the second zone and within a second threshold angle of the second zone.

16. The information handling system of claim 15, wherein the circuitry is further configured to:
permit, via the anisotropic material, the first information along the first axis of the first zone to be viewed by at least one person.

17. The information handling system of claim 15,
wherein the circuitry is further configured to:
determine a media classification; and
wherein the circuitry obscures, via the anisotropic material, the first information along the second axis of the first zone and within the second threshold angle of the first zone in response to determining the media classification.

18. The information handling system of claim 15, wherein the anisotropic material includes a first plurality of strips, having a first height, associated with the first axis and a second plurality of strips, having a second height, associated with the second axis.

19. The information handling system of claim 18,
wherein the first plurality of strips and the second plurality of strips form apertures of the first zone; and
wherein a centroid of the apertures of the first zone determines one or more positions where the first information is obscured.

20. The information handling system of claim 18,
wherein the first information is displayed via a first portion of the first light emissions; and
wherein the first plurality of strips obscure the first portion of the first light emissions.
